(19) United States
(12) Patent Application Publication
(10) Pub. No.: US 2024/0039742 A1
(43) Pub. Date: Feb. 1, 2024

(54) ALERT ACCOUNT

(71) Applicant: nChain Licensing AG, Zug (CH)

(72) Inventors: Liuxuan PAN, London (GB); Chloe TARTAN, London (GB); Craig Steven WRIGHT, London (GB)

(21) Appl. No.: 18/022,241

(22) PCT Filed: Jul. 21, 2021
(86) PCT No.: PCT/EP2021/070327

§ 371 Date: Feb. 20, 2023

(30) Foreign Application Priority Data
Aug. 21, 2020 (GB) 2013056.3

(51) Int. Cl. H04L 9/00; H04L 9/06; H04L 9/30

(52) U.S. Cl. CPC H04L 9/50; H04L 9/0637; H04L 9/30

(57) ABSTRACT

A computer-implemented method of alerting users to on-chain events, wherein a primary user is associated with a primary user public key, and wherein the method is performed by an alerting entity and comprises: identifying one or more event transactions, wherein each event transaction comprising respective event data; generating a primary alert transaction, wherein the primary alert transaction comprises a first output locked to the primary user public key, and a second output comprising alert data, and wherein the alert data comprises a respective identifier of each identified event transaction; and transmitting the primary alert transaction to the blockchain network.

### CROSS REFERENCE TO RELATED APPLICATIONS

This application is the U.S. National Stage of International Application No. PCT/EP2021/070327 filed on Jul. 21, 2021, which claims the benefit of United Kingdom Patent Application No. 2013056.3, filed on Aug. 21, 2020, the contents of which are incorporated herein by reference in their entireties.

### TECHNICAL FIELD

The present disclosure relates to a method of alerting users to on-chain events. In particular, the method enables on-chain events to be consolidated into a user's account, which is represented by a user's public key.

### BACKGROUND

A blockchain refers to a form of distributed data structure, wherein a duplicate copy of the blockchain is maintained at each of a plurality of nodes in a distributed peer-to-peer (P2P) network (referred to below as a “blockchain network”) and widely publicised. The blockchain comprises a chain of blocks of data, wherein each block comprises one or more transactions. Each transaction, other than so-called “coinbase transactions”, points back to a preceding transaction in a sequence which may span one or more blocks going back to one or more coinbase transactions. Coinbase transactions are discussed further below. Transactions that are submitted to the blockchain network are included in new blocks. New blocks are created by a process often referred to as “mining”, which involves each of a plurality of the nodes competing to perform “proof-of-work”, i.e. solving a cryptographic puzzle based on a representation of a defined set of ordered and validated pending transactions waiting to be included in a new block of the blockchain. It should be noted that the blockchain may be pruned at some nodes, and the publication of blocks can be achieved through the publication of mere block headers.

The transactions in the blockchain may be used for one or more of the following purposes: to convey a digital asset (i.e. a number of digital tokens), to order a set of entries in a virtualised ledger or registry, to receive and process timestamp entries, and/or to time-order index pointers. A blockchain can also be exploited in order to layer additional functionality on top of the blockchain. For example blockchain protocols may allow for storage of additional user data or indexes to data in a transaction. There is no pre-specified limit to the maximum data capacity that can be stored within a single transaction, and therefore increasingly more complex data can be incorporated. For instance this may be used to store an electronic document in the blockchain, or audio or video data.

Nodes of the blockchain network (which are often referred to as “miners”) perform a distributed transaction registration and verification process, which will be described in more detail later. In summary, during this process a node validates transactions and inserts them into a block template for which they attempt to identify a valid proof-of-work solution. Once a valid solution is found, a new block is propagated to other nodes of the network, thus enabling each node to record the new block on the blockchain. In order to have a transaction recorded in the blockchain, a user (e.g. a blockchain client application) sends the transaction to one of the nodes of the network to be propagated. Nodes which receive the transaction may race to find a proof-of-work solution incorporating the validated transaction into a new block. Each node is configured to enforce the same node protocol, which will include one or more conditions for a transaction to be valid. Invalid transactions will not be propagated nor incorporated into blocks. Assuming the transaction is validated and thereby accepted onto the blockchain, then the transaction (including any user data) will thus remain registered and indexed at each of the nodes in the blockchain network as an immutable public record.

The node who successfully solved the proof-of-work puzzle to create the latest block is typically rewarded with a new transaction called the “coinbase transaction” which distributes an amount of the digital asset, i.e. a number of tokens. The detection and rejection of invalid transactions is enforced by the actions of competing nodes who act as agents of the network and are incentivised to report and block malfeasance. The widespread publication of information allows users to continuously audit the performance of nodes. The publication of the mere block headers allows participants to ensure the ongoing integrity of the blockchain.

In an “output-based” model (sometimes referred to as a UTXO-based model), the data structure of a given transaction comprises one or more inputs and one or more outputs. Any spendable output comprises an element specifying an amount of the digital asset that is derivable from the proceeding sequence of transactions. The spendable output is sometimes referred to as a UTXO (“unspent transaction output”). The output may further comprise a locking script specifying a condition for the future redemption of the output. A locking script is a predicate defining the conditions necessary to validate and transfer digital tokens or assets. Each input of a transaction (other than a coinbase transaction) comprises a pointer (i.e. a reference) to such an output in a preceding transaction, and may further comprise an unlocking script for unlocking the locking script of the pointed-to output. So consider a pair of transactions, call them a first and a second transaction (or “target” transaction). The first transaction comprises at least one output specifying an amount of the digital asset, and comprising a locking script defining one or more conditions of unlocking the output. The second, target transaction comprises at least one input, comprising a pointer to the output of the first transaction, and an unlocking script for unlocking the output of the first transaction.

In such a model, when the second, target transaction is sent to the blockchain network to be propagated and recorded in the blockchain, one of the criteria for validity applied at each node will be that the unlocking script meets all of the one or more conditions defined in the locking script of the first transaction. Another will be that the output of the first transaction has not already been redeemed by another, earlier valid transaction. Any node that finds the target transaction invalid according to any of these conditions will not propagate it (as a valid transaction, but possibly to register an invalid transaction) nor include it in a new block to be recorded in the blockchain.

An alternative type of transaction model is an account-based model. In this case each transaction does not define the amount to be transferred by referring back to the UTXO of a preceding transaction in a sequence of past transactions, but rather by reference to an absolute account balance. The current state of all accounts is stored by the nodes separate to the blockchain and is updated constantly.

### SUMMARY

Applications that utilise the blockchain often store activities, or activity-related data, in transactions, e.g. climate and weather related data specific to a particular location, or invoices related to payments. There are two main ways in which a user can monitor these activities using the data stored on the blockchain. First, the user may search the blockchain for specific events of interest. Secondly, the individual may make use of the application that has submitted the data to the blockchain, e.g. a weather application for obtaining the previously mentioned weather data. Neither of these methods are satisfactory. For the first method, the majority of users do not have enough resources, including searching capabilities and the time, to monitor the blockchain and identify relevant transactions. For the second method, since a wide variety of activities may be recorded on the blockchain, each by different applications, the user would need to check each individual application in order to obtain the desired information.

It would therefore be desirable to provide a solution that enables a user to obtain the event (i.e. activity) related information, and which does not suffer from the same problems as existing techniques.

According to one aspect disclosed herein, there is provided a computer-implemented method of alerting users to on-chain events, wherein a primary user is associated with a primary user public key, and wherein the method is performed by an alerting entity and comprises: identifying one or more event transactions, wherein each event transaction comprises respective event data; generating a primary alert transaction, wherein the primary alert transaction comprises a first output locked to the primary user public key, and a second output comprising alert data, and wherein the alert data comprises a respective identifier of each identified event transaction; and transmitting the primary alert transaction to the blockchain network.

According to another aspect disclosed herein, there is provided a computer-implemented method of obtaining on-chain events, wherein a blockchain comprises one or more event transactions, each event transaction comprising respective event data, wherein the method is performed by a user associated with a user public key, and wherein the method comprises: obtaining an alert transaction, wherein the alert transaction comprises a first output locked to the user public key, and a second output comprising alert data, and wherein the alert data comprises a respective identifier of one or more event transactions; and using at least one respective identifier of a respective event transaction to obtain the respective event data.

The primary user (Alice) has a primary public key, i.e. a main public key. This may be a certified public key certified as belonging to Alice. Alice's primary public key is now used as an account. The alerting entity (e.g. a service provider) detects events and sends an alert transaction to Alice's account, i.e. her primary public key. The alert transaction includes the transaction identifiers (TxIDs) of the events. This enables event information relevant to, or associated with, Alice to be consolidated into her account.

Account-based blockchains are mentioned briefly above. The present invention enables some of the advantages of an account-based blockchain to be obtained on a scalable, output-based blockchain, e.g. bitcoin.

As an example use case, the on-chain events may be transactions that have been sent to different public keys that associated with Alice, e.g. linked to her certified public key. For security reasons it is good practice not to re-use a cryptographic key, which means that Alice may have many associated public keys, each of which may at some point receive a payment, i.e. an output of a transaction is locked to a public key. Note that “payment” is used in a general sense and does not necessarily mean payment for goods or services, e.g. an output may be assigned to one of Alice's public keys for some other reason. In any case, the service provider may collect the transaction identifiers of transactions that have been sent to Alice (e.g. over a certain period of time), and consolidate them in an alert transaction sent to Alice's account (i.e. her primary public key). This is convenient for Alice because she does not have to spend time and other resources monitoring for payments to all of her public keys. In addition, Alice now effectively has a reference to at least some of her UTXOs in one place (by virtue of having their corresponding TxIDs stored in alert transactions sent to the same primary public key).

The UTXO of the alert transaction may be a minimum value for allowing the alert transaction to be published on the bitcoin blockchain. The primary public key only receives on-chain alert messages and is restricted to the movement of funds to this account. In the event that the private key corresponding to Alice's primary public key is hacked (stolen), the losses are therefore limited to the minimum values of the alert transactions.

### BRIEF DESCRIPTION OF THE DRAWINGS

To assist understanding of embodiments of the present disclosure and to show how such embodiments may be put into effect, reference is made, by way of example only, to the accompanying drawings in which:

FIG. 1 is a schematic block diagram of a system for implementing a blockchain,

FIG. 2 schematically illustrates some examples of transactions which may be recorded in a blockchain,

FIG. 3A is a schematic block diagram of a client application,

FIG. 3B is a schematic mock-up of an example user interface that may be presented by the client application of FIG. 3A,

FIGS. 4A and 4B are schematic block diagram of different embodiments of the present invention for alerting a user to on-chain events,

FIG. 5 is a schematic block diagram showing an example flow of transactions according to some embodiments of the present invention, and

FIG. 6 is a schematic block diagram showing an example flow of transactions according to some other embodiments of the present invention.

### DETAILED DESCRIPTION OF EMBODIMENTS

### Example System Overview

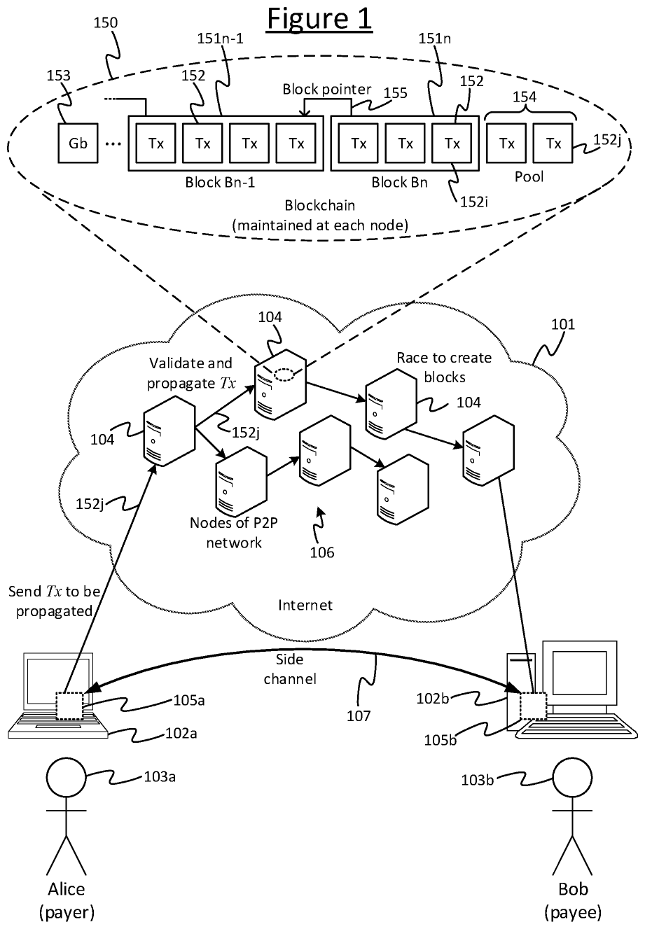

FIG. 1 shows an example system 100 for implementing a blockchain 150. The system 100 may comprise of a packet-switched network 101, typically a wide-area internetwork such as the Internet. The packet-switched network 101 comprises a plurality of blockchain nodes 104 that may be arranged to form a peer-to-peer (P2P) network 106 within the packet-switched network 101. Whilst not illustrated, the blockchain nodes 104 may be arranged as a near-complete graph. Each blockchain node 104 is therefore highly connected to other blockchain nodes 104.

Each blockchain node 104 comprises computer equipment of a peer, with different ones of the nodes 104 belonging to different peers. Each blockchain node 104 comprises processing apparatus comprising one or more processors, e.g. one or more central processing units (CPUs), accelerator processors, application specific processors and/or field programmable gate arrays (FPGAs), and other equipment such as application specific integrated circuits (ASICs). Each node also comprises memory, i.e. computer-readable storage in the form of a non-transitory computer-readable medium or media. The memory may comprise one or more memory units employing one or more memory media, e.g. a magnetic medium such as a hard disk; an electronic medium such as a solid-state drive (SSD), flash memory or EEPROM; and/or an optical medium such as an optical disk drive.

The blockchain 150 comprises a chain of blocks of data 151, wherein a respective copy of the blockchain 150 is maintained at each of a plurality of blockchain nodes 104 in the distributed or blockchain network 106. As mentioned above, maintaining a copy of the blockchain 150 does not necessarily mean storing the blockchain 150 in full. Instead, the blockchain 150 may be pruned of data so long as each blockchain node 150 stores the block header (discussed below) of each block 151. Each block 151 in the chain comprises one or more transactions 152, wherein a transaction in this context refers to a kind of data structure. The nature of the data structure will depend on the type of transaction protocol used as part of a transaction model or scheme. A given blockchain will use one particular transaction protocol throughout. In one common type of transaction protocol, the data structure of each transaction 152 comprises at least one input and at least one output. Each output specifies an amount representing a quantity of a digital asset as property, an example of which is a user 103 to whom the output is cryptographically locked (requiring a signature or other solution of that user in order to be unlocked and thereby redeemed or spent). Each input points back to the output of a preceding transaction 152, thereby linking the transactions.

Each block 151 also comprises a block pointer 155 pointing back to the previously created block 151 in the chain so as to define a sequential order to the blocks 151. Each transaction 152 (other than a coinbase transaction) comprises a pointer back to a previous transaction so as to define an order to sequences of transactions (N.B. sequences of transactions 152 are allowed to branch). The chain of blocks 151 goes all the way back to a genesis block (Gb) 153 which was the first block in the chain. One or more original transactions 152 early on in the chain 150 pointed to the genesis block 153 rather than a preceding transaction.

Each of the blockchain nodes 104 is configured to forward transactions 152 to other blockchain nodes 104, and thereby cause transactions 152 to be propagated throughout the network 106. Each blockchain node 104 is configured to create blocks 151 and to store a respective copy of the same blockchain 150 in their respective memory. Each blockchain node 104 also maintains an ordered set (or “pool”) 154 of transactions 152 waiting to be incorporated into blocks 151. The ordered pool 154 is often referred to as a “mempool”. This term herein is not intended to limit to any particular blockchain, protocol or model. It refers to the ordered set of transactions which a node 104 has accepted as valid and for which the node 104 is obliged not to accept any other transactions attempting to spend the same output.

In a given present transaction 152j, the (or each) input comprises a pointer referencing the output of a preceding transaction 152i in the sequence of transactions, specifying that this output is to be redeemed or “spent” in the present transaction 152j. In general, the preceding transaction could be any transaction in the ordered set 154 or any block 151. The preceding transaction 152i need not necessarily exist at the time the present transaction 152j is created or even sent to the network 106, though the preceding transaction 152i will need to exist and be validated in order for the present transaction to be valid. Hence “preceding” herein refers to a predecessor in a logical sequence linked by pointers, not necessarily the time of creation or sending in a temporal sequence, and hence it does not necessarily exclude that the transactions 152i, 152j be created or sent out-of-order (see discussion below on orphan transactions). The preceding transaction 152i could equally be called the antecedent or predecessor transaction.

The input of the present transaction 152j also comprises the input authorisation, for example the signature of the user 103a to whom the output of the preceding transaction 152i is locked. In turn, the output of the present transaction 152j can be cryptographically locked to a new user or entity 103b. The present transaction 152j can thus transfer the amount defined in the input of the preceding transaction 152i to the new user or entity 103b as defined in the output of the present transaction 152j. In some cases a transaction 152 may have multiple outputs to split the input amount between multiple users or entities (one of whom could be the original user or entity 103a in order to give change). In some cases a transaction can also have multiple inputs to gather together the amounts from multiple outputs of one or more preceding transactions, and redistribute to one or more outputs of the current transaction.

According to an output-based transaction protocol such as bitcoin, when a party 103, such as an individual user or an organization, wishes to enact a new transaction 152j (either manually or by an automated process employed by the party), then the enacting party sends the new transaction from its computer terminal 102 to a recipient. The enacting party or the recipient will eventually send this transaction to one or more of the blockchain nodes 104 of the network 106 (which nowadays are typically servers or data centres, but could in principle be other user terminals). It is also not excluded that the party 103 enacting the new transaction 152j could send the transaction directly to one or more of the blockchain nodes 104 and, in some examples, not to the recipient. A blockchain node 104 that receives a transaction checks whether the transaction is valid according to a blockchain node protocol which is applied at each of the blockchain nodes 104. The blockchain node protocol typically requires the blockchain node 104 to check that a cryptographic signature in the new transaction 152j matches the expected signature, which depends on the previous transaction 152i in an ordered sequence of transactions 152. In such an output-based transaction protocol, this may comprise checking that the cryptographic signature or other authorisation of the party 103 included in the input of the new transaction 152j matches a condition defined in the output of the preceding transaction 152i which the new transaction assigns, wherein this condition typically comprises at least checking that the cryptographic signature or other authorisation in the input of the new transaction 152j unlocks the output of the previous transaction 152i to which the input of the new transaction is linked to. The condition may be at least partially defined by a script included in the output of the preceding transaction 152i. Alternatively it could simply be fixed by the blockchain node protocol alone, or it could be due to a combination of these. Either way, if the new transaction 152j is valid, the blockchain node 104 forwards it to one or more other blockchain nodes 104 in the blockchain network 106. These other blockchain nodes 104 apply the same test according to the same blockchain node protocol, and so forward the new transaction 152j on to one or more further nodes 104, and so forth. In this way the new transaction is propagated throughout the network of blockchain nodes 104.

In an output-based model, the definition of whether a given output (e.g. UTXO) is assigned (e.g. spent) is whether it has yet been validly redeemed by the input of another, onward transaction 152j according to the blockchain node protocol. Another condition for a transaction to be valid is that the output of the preceding transaction 152i which it attempts to redeem has not already been redeemed by another transaction. Again if not valid, the transaction 152j will not be propagated (unless flagged as invalid and propagated for alerting) or recorded in the blockchain 150. This guards against double-spending whereby the transactor tries to assign the output of the same transaction more than once. An account-based model on the other hand guards against double-spending by maintaining an account balance. Because again there is a defined order of transactions, the account balance has a single defined state at any one time.

In addition to validating transactions, blockchain nodes 104 also race to be the first to create blocks of transactions in a process commonly referred to as mining, which is supported by “proof-of-work”. At a blockchain node 104, new transactions are added to an ordered pool 154 of valid transactions that have not yet appeared in a block 151 recorded on the blockchain 150. The blockchain nodes then race to assemble a new valid block 151 of transactions 152 from the ordered set of transactions 154 by attempting to solve a cryptographic puzzle. Typically this comprises searching for a “nonce” value such that when the nonce is concatenated with a representation of the ordered pool of pending transactions 154 and hashed, then the output of the hash meets a predetermined condition. E.g. the predetermined condition may be that the output of the hash has a certain predefined number of leading zeros. Note that this is just one particular type of proof-of-work puzzle, and other types are not excluded. A property of a hash function is that it has an unpredictable output with respect to its input. Therefore this search can only be performed by brute force, thus consuming a substantive amount of processing resource at each blockchain node 104 that is trying to solve the puzzle.

The first blockchain node 104 to solve the puzzle announces this to the network 106, providing the solution as proof which can then be easily checked by the other blockchain nodes 104 in the network (once given the solution to a hash it is straightforward to check that it causes the output of the hash to meet the condition). The first blockchain node 104 propagates a block to a threshold consensus of other nodes that accept the block and thus enforce the protocol rules. The ordered set of transactions 154 then becomes recorded as a new block 151 in the blockchain 150 by each of the blockchain nodes 104. A block pointer 155 is also assigned to the new block 151n pointing back to the previously created block 151n−1 in the chain. The significant amount of effort, for example in the form of hash, required to create a proof-of-work solution signals the intent of the first node 104 to follow the rules of the blockchain protocol. Such rules include not accepting a transaction as valid if it assigns the same output as a previously validated transaction, otherwise known as double-spending. Once created, the block 151 cannot be modified since it is recognized and maintained at each of the blockchain nodes 104 in the blockchain network 106. The block pointer 155 also imposes a sequential order to the blocks 151. Since the transactions 152 are recorded in the ordered blocks at each blockchain node 104 in a network 106, this therefore provides an immutable public ledger of the transactions.

Note that different blockchain nodes 104 racing to solve the puzzle at any given time may be doing so based on different snapshots of the pool of yet-to-be published transactions 154 at any given time, depending on when they started searching for a solution or the order in which the transactions were received. Whoever solves their respective puzzle first defines which transactions 152 are included in the next new block 151n and in which order, and the current pool 154 of unpublished transactions is updated. The blockchain nodes 104 then continue to race to create a block from the newly-defined ordered pool of unpublished transactions 154, and so forth. A protocol also exists for resolving any “fork” that may arise, which is where two blockchain nodes 104 solve their puzzle within a very short time of one another such that a conflicting view of the blockchain gets propagated between nodes 104. In short, whichever prong of the fork grows the longest becomes the definitive blockchain 150. Note this should not affect the users or agents of the network as the same transactions will appear in both forks.

According to the bitcoin blockchain (and most other blockchains) a node that successfully constructs a new block 104 is granted the ability to newly assign an additional, accepted amount of the digital asset in a new special kind of transaction which distributes an additional defined quantity of the digital asset (as opposed to an inter-agent, or inter-user transaction which transfers an amount of the digital asset from one agent or user to another). This special type of transaction is usually referred to as a “coinbase transaction”, but may also be termed an “initiation transaction” or “generation transaction”. It typically forms the first transaction of the new block 151n. The proof-of-work signals the intent of the node that constructs the new block to follow the protocol rules allowing this special transaction to be redeemed later. The blockchain protocol rules may require a maturity period, for example 100 blocks, before this special transaction may be redeemed. Often a regular (non-generation) transaction 152 will also specify an additional transaction fee in one of its outputs, to further reward the blockchain node 104 that created the block 151n in which that transaction was published. This fee is normally referred to as the “transaction fee”, and is discussed blow.

Due to the resources involved in transaction validation and publication, typically at least each of the blockchain nodes 104 takes the form of a server comprising one or more physical server units, or even whole a data centre. However in principle any given blockchain node 104 could take the form of a user terminal or a group of user terminals networked together.

The memory of each blockchain node 104 stores software configured to run on the processing apparatus of the blockchain node 104 in order to perform its respective role or roles and handle transactions 152 in accordance with the blockchain node protocol. It will be understood that any action attributed herein to a blockchain node 104 may be performed by the software run on the processing apparatus of the respective computer equipment. The node software may be implemented in one or more applications at the application layer, or a lower layer such as the operating system layer or a protocol layer, or any combination of these.

Also connected to the network 101 is the computer equipment 102 of each of a plurality of parties 103 in the role of consuming users. These users may interact with the blockchain network 106 but do not participate in validating transactions or constructing blocks. Some of these users or agents 103 may act as senders and recipients in transactions. Other users may interact with the blockchain 150 without necessarily acting as senders or recipients. For instance, some parties may act as storage entities that store a copy of the blockchain 150 (e.g. having obtained a copy of the blockchain from a blockchain node 104).

Some or all of the parties 103 may be connected as part of a different network, e.g. a network overlaid on top of the blockchain network 106. Users of the blockchain network (often referred to as “clients”) may be said to be part of a system that includes the blockchain network 106; however, these users are not blockchain nodes 104 as they do not perform the roles required of the blockchain nodes. Instead, each party 103 may interact with the blockchain network 106 and thereby utilize the blockchain 150 by connecting to (i.e. communicating with) a blockchain node 104. Two parties 103 and their respective equipment 102 are shown for illustrative purposes: a first party 103a and his/her respective computer equipment 102a, and a second party 103b and his/her respective computer equipment 102b. It will be understood that many more such parties 103 and their respective computer equipment 102 may be present and participating in the system 100, but for convenience they are not illustrated. Each party 103 may be an individual or an organization. Purely by way of illustration the first party 103a is referred to herein as Alice and the second party 103b is referred to as Bob, but it will be appreciated that this is not limiting and any reference herein to Alice or Bob may be replaced with “first party” and “second “party” respectively.

The computer equipment 102 of each party 103 comprises respective processing apparatus comprising one or more processors, e.g. one or more CPUs, GPUs, other accelerator processors, application specific processors, and/or FPGAs. The computer equipment 102 of each party 103 further comprises memory, i.e. computer-readable storage in the form of a non-transitory computer-readable medium or media. This memory may comprise one or more memory units employing one or more memory media, e.g. a magnetic medium such as hard disk; an electronic medium such as an SSD, flash memory or EEPROM; and/or an optical medium such as an optical disc drive. The memory on the computer equipment 102 of each party 103 stores software comprising a respective instance of at least one client application 105 arranged to run on the processing apparatus. It will be understood that any action attributed herein to a given party 103 may be performed using the software run on the processing apparatus of the respective computer equipment 102. The computer equipment 102 of each party 103 comprises at least one user terminal, e.g. a desktop or laptop computer, a tablet, a smartphone, or a wearable device such as a smartwatch. The computer equipment 102 of a given party 103 may also comprise one or more other networked resources, such as cloud computing resources accessed via the user terminal.

The client application 105 may be initially provided to the computer equipment 102 of any given party 103 on suitable computer-readable storage medium or media, e.g. downloaded from a server, or provided on a removable storage device such as a removable SSD, flash memory key, removable EEPROM, removable magnetic disk drive, magnetic floppy disk or tape, optical disk such as a CD or DVD ROM, or a removable optical drive, etc.

The client application 105 comprises at least a “wallet” function. This has two main functionalities. One of these is to enable the respective party 103 to create, authorise (for example sign) and send transactions 152 to one or more bitcoin nodes 104 to then be propagated throughout the network of blockchain nodes 104 and thereby included in the blockchain 150. The other is to report back to the respective party the amount of the digital asset that he or she currently owns. In an output-based system, this second functionality comprises collating the amounts defined in the outputs of the various 152 transactions scattered throughout the blockchain 150 that belong to the party in question.

Note: whilst the various client functionality may be described as being integrated into a given client application 105, this is not necessarily limiting and instead any client functionality described herein may instead be implemented in a suite of two or more distinct applications, e.g. interfacing via an API, or one being a plug-in to the other. More generally the client functionality could be implemented at the application layer or a lower layer such as the operating system, or any combination of these. The following will be described in terms of a client application 105 but it will be appreciated that this is not limiting.

The instance of the client application or software 105 on each computer equipment 102 is operatively coupled to at least one of the blockchain nodes 104 of the network 106. This enables the wallet function of the client 105 to send transactions 152 to the network 106. The client 105 is also able to contact blockchain nodes 104 in order to query the blockchain 150 for any transactions of which the respective party 103 is the recipient (or indeed inspect other parties' transactions in the blockchain 150, since in embodiments the blockchain 150 is a public facility which provides trust in transactions in part through its public visibility). The wallet function on each computer equipment 102 is configured to formulate and send transactions 152 according to a transaction protocol. As set out above, each blockchain node 104 runs software configured to validate transactions 152 according to the blockchain node protocol, and to forward transactions 152 in order to propagate them throughout the blockchain network 106. The transaction protocol and the node protocol correspond to one another, and a given transaction protocol goes with a given node protocol, together implementing a given transaction model. The same transaction protocol is used for all transactions 152 in the blockchain 150. The same node protocol is used by all the nodes 104 in the network 106.

When a given party 103, say Alice, wishes to send a new transaction 152j to be included in the blockchain 150, then she formulates the new transaction in accordance with the relevant transaction protocol (using the wallet function in her client application 105). She then sends the transaction 152 from the client application 105 to one or more blockchain nodes 104 to which she is connected. E.g. this could be the blockchain node 104 that is best connected to Alice's computer 102. When any given blockchain node 104 receives a new transaction 152j, it handles it in accordance with the blockchain node protocol and its respective role. This comprises first checking whether the newly received transaction 152j meets a certain condition for being “valid”, examples of which will be discussed in more detail shortly. In some transaction protocols, the condition for validation may be configurable on a per-transaction basis by scripts included in the transactions 152. Alternatively the condition could simply be a built-in feature of the node protocol, or be defined by a combination of the script and the node protocol.

On condition that the newly received transaction 152j passes the test for being deemed valid (i.e. on condition that it is “validated”), any blockchain node 104 that receives the transaction 152j will add the new validated transaction 152 to the ordered set of transactions 154 maintained at that blockchain node 104. Further, any blockchain node 104 that receives the transaction 152j will propagate the validated transaction 152 onward to one or more other blockchain nodes 104 in the network 106. Since each blockchain node 104 applies the same protocol, then assuming the transaction 152j is valid, this means it will soon be propagated throughout the whole network 106.

Once admitted to the ordered pool of pending transactions 154 maintained at a given blockchain node 104, that blockchain node 104 will start competing to solve the proof-of-work puzzle on the latest version of their respective pool of 154 including the new transaction 152 (recall that other blockchain nodes 104 may be trying to solve the puzzle based on a different pool of transactions 154, but whoever gets there first will define the set of transactions that are included in the latest block 151. Eventually a blockchain node 104 will solve the puzzle for a part of the ordered pool 154 which includes Alice's transaction 152j). Once the proof-of-work has been done for the pool 154 including the new transaction 152j, it immutably becomes part of one of the blocks 151 in the blockchain 150. Each transaction 152 comprises a pointer back to an earlier transaction, so the order of the transactions is also immutably recorded.

Different blockchain nodes 104 may receive different instances of a given transaction first and therefore have conflicting views of which instance is ‘valid’ before one instance is published in a new block 151, at which point all blockchain nodes 104 agree that the published instance is the only valid instance. If a blockchain node 104 accepts one instance as valid, and then discovers that a second instance has been recorded in the blockchain 150 then that blockchain node 104 must accept this and will discard (i.e. treat as invalid) the instance which it had initially accepted (i.e. the one that has not been published in a block 151).

An alternative type of transaction protocol operated by some blockchain networks may be referred to as an “account-based” protocol, as part of an account-based transaction model. In the account-based case, each transaction does not define the amount to be transferred by referring back to the UTXO of a preceding transaction in a sequence of past transactions, but rather by reference to an absolute account balance. The current state of all accounts is stored, by the nodes of that network, separate to the blockchain and is updated constantly. In such a system, transactions are ordered using a running transaction tally of the account (also called the “position”). This value is signed by the sender as part of their cryptographic signature and is hashed as part of the transaction reference calculation. In addition, an optional data field may also be signed the transaction. This data field may point back to a previous transaction, for example if the previous transaction ID is included in the data field.

### UTXO-Based Model

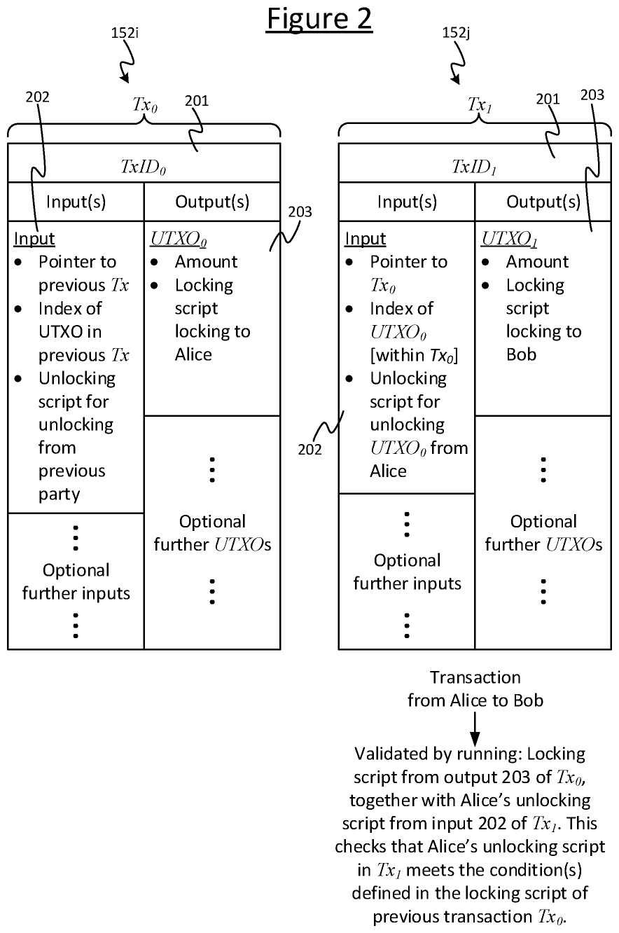

FIG. 2 illustrates an example transaction protocol. This is an example of a UTXO-based protocol. A transaction 152 (abbreviated “Tx”) is the fundamental data structure of the blockchain 150 (each block 151 comprising one or more transactions 152). The following will be described by reference to an output-based or “UTXO” based protocol. However, this is not limiting to all possible embodiments. Note that while the example UTXO-based protocol is described with reference to bitcoin, it may equally be implemented on other example blockchain networks.

In a UTXO-based model, each transaction (“Tx”) 152 comprises a data structure comprising one or more inputs 202, and one or more outputs 203. Each output 203 may comprise an unspent transaction output (UTXO), which can be used as the source for the input 202 of another new transaction (if the UTXO has not already been redeemed). The UTXO includes a value specifying an amount of a digital asset. This represents a set number of tokens on the distributed ledger. The UTXO may also contain the transaction ID of the transaction from which it came, amongst other information. The transaction data structure may also comprise a header 201, which may comprise an indicator of the size of the input field(s) 202 and output field(s) 203. The header 201 may also include an ID of the transaction. In embodiments the transaction ID is the hash of the transaction data (excluding the transaction ID itself) and stored in the header 201 of the raw transaction 152 submitted to the nodes 104.

Say Alice 103a wishes to create a transaction 152j transferring an amount of the digital asset in question to Bob 103b. In FIG. 2 Alice's new transaction 152j is labelled “Tx₁”. It takes an amount of the digital asset that is locked to Alice in the output 203 of a preceding transaction 152i in the sequence, and transfers at least some of this to Bob. The preceding transaction 152i is labelled “Tx₀” in FIG. 2. Tx₀ and Tx₁ are just arbitrary labels. They do not necessarily mean that Tx₀ is the first transaction in the blockchain 151, nor that Tx₁ is the immediate next transaction in the pool 154. Tx₁ could point back to any preceding (i.e. antecedent) transaction that still has an unspent output 203 locked to Alice.

The preceding transaction Tx₀ may already have been validated and included in a block 151 of the blockchain 150 at the time when Alice creates her new transaction Tx₁, or at least by the time she sends it to the network 106. It may already have been included in one of the blocks 151 at that time, or it may be still waiting in the ordered set 154 in which case it will soon be included in a new block 151. Alternatively Tx₀ and Tx₁ could be created and sent to the network 106 together, or Tx₀ could even be sent after Tx₁ if the node protocol allows for buffering “orphan” transactions. The terms “preceding” and “subsequent” as used herein in the context of the sequence of transactions refer to the order of the transactions in the sequence as defined by the transaction pointers specified in the transactions (which transaction points back to which other transaction, and so forth). They could equally be replaced with “predecessor” and “successor”, or “antecedent” and “descendant”, “parent” and “child”, or such like. It does not necessarily imply an order in which they are created, sent to the network 106, or arrive at any given blockchain node 104. Nevertheless, a subsequent transaction (the descendent transaction or “child”) which points to a preceding transaction (the antecedent transaction or “parent”) will not be validated until and unless the parent transaction is validated. A child that arrives at a blockchain node 104 before its parent is considered an orphan. It may be discarded or buffered for a certain time to wait for the parent, depending on the node protocol and/or node behaviour.

One of the one or more outputs 203 of the preceding transaction Tx₀ comprises a particular UTXO, labelled here UTXO₀. Each UTXO comprises a value specifying an amount of the digital asset represented by the UTXO, and a locking script which defines a condition which must be met by an unlocking script in the input 202 of a subsequent transaction in order for the subsequent transaction to be validated, and therefore for the UTXO to be successfully redeemed. Typically the locking script locks the amount to a particular party (the beneficiary of the transaction in which it is included). I.e. the locking script defines an unlocking condition, typically comprising a condition that the unlocking script in the input of the subsequent transaction comprises the cryptographic signature of the party to whom the preceding transaction is locked.

The locking script (aka scriptPubKey) is a piece of code written in the domain specific language recognized by the node protocol. A particular example of such a language is called “Script” (capital S) which is used by the blockchain network. The locking script specifies what information is required to spend a transaction output 203, for example the requirement of Alice's signature. Unlocking scripts appear in the outputs of transactions. The unlocking script (aka scriptSig) is a piece of code written the domain specific language that provides the information required to satisfy the locking script criteria. For example, it may contain Bob's signature. Unlocking scripts appear in the input 202 of transactions.

So in the example illustrated, UTXO₀ in the output 203 of Tx₀ comprises a locking script [Checksig P_{A}] which requires a signature Sig P_{A} of Alice in order for UTXO₀ to be redeemed (strictly, in order for a subsequent transaction attempting to redeem UTXO₀ to be valid). [Checksig P_{A}] contains a representation (i.e. a hash) of the public key P_{A} from a public-private key pair of Alice. The input 202 of Tx₁ comprises a pointer pointing back to Tx₁ (e.g. by means of its transaction ID, TxID₀, which in embodiments is the hash of the whole transaction Tx₀). The input 202 of Tx₁ comprises an index identifying UTXO₀ within Tx₀, to identify it amongst any other possible outputs of Tx₀. The input 202 of Tx₁ further comprises an unlocking script <Sig P_{A}> which comprises a cryptographic signature of Alice, created by Alice applying her private key from the key pair to a predefined portion of data (sometimes called the “message” in cryptography). The data (or “message”) that needs to be signed by Alice to provide a valid signature may be defined by the locking script, or by the node protocol, or by a combination of these.

When the new transaction Tx₁ arrives at a blockchain node 104, the node applies the node protocol. This comprises running the locking script and unlocking script together to check whether the unlocking script meets the condition defined in the locking script (where this condition may comprise one or more criteria). In embodiments this involves concatenating the two scripts:

<Sig P_{A}><P_{A}>∥[Checksig P_{A}]

where “∥” represents a concatenation and “< . . . >” means place the data on the stack, and “[. . . ]” is a function comprised by the locking script (in this example a stack-based language). Equivalently the scripts may be run one after the other, with a common stack, rather than concatenating the scripts. Either way, when run together, the scripts use the public key P_{A}of Alice, as included in the locking script in the output of Tx₀, to authenticate that the unlocking script in the input of Tx₁ contains the signature of Alice signing the expected portion of data. The expected portion of data itself (the “message”) also needs to be included in order to perform this authentication. In embodiments the signed data comprises the whole of Tx₁ (so a separate element does not need to be included specifying the signed portion of data in the clear, as it is already inherently present).

The details of authentication by public-private cryptography will be familiar to a person skilled in the art. Basically, if Alice has signed a message using her private key, then given Alice's public key and the message in the clear, another entity such as a node 104 is able to authenticate that the message must have been signed by Alice. Signing typically comprises hashing the message, signing the hash, and tagging this onto the message as a signature, thus enabling any holder of the public key to authenticate the signature. Note therefore that any reference herein to signing a particular piece of data or part of a transaction, or such like, can in embodiments mean signing a hash of that piece of data or part of the transaction.

If the unlocking script in Tx₁ meets the one or more conditions specified in the locking script of Tx₀ (so in the example shown, if Alice's signature is provided in Tx₁ and authenticated), then the blockchain node 104 deems Tx₁ valid. This means that the blockchain node 104 will add Tx₁ to the ordered pool of pending transactions 154. The blockchain node 104 will also forward the transaction Tx₁ to one or more other blockchain nodes 104 in the network 106, so that it will be propagated throughout the network 106. Once Tx₁ has been validated and included in the blockchain 150, this defines UTXO₀ from Tx₀ as spent. Note that Tx₁ can only be valid if it spends an unspent transaction output 203. If it attempts to spend an output that has already been spent by another transaction 152, then Tx₁ will be invalid even if all the other conditions are met. Hence the blockchain node 104 also needs to check whether the referenced UTXO in the preceding transaction Tx₀ is already spent (i.e. whether it has already formed a valid input to another valid transaction). This is one reason why it is important for the blockchain 150 to impose a defined order on the transactions 152. In practice a given blockchain node 104 may maintain a separate database marking which UTXOs 203 in which transactions 152 have been spent, but ultimately what defines whether a UTXO has been spent is whether it has already formed a valid input to another valid transaction in the blockchain 150.

If the total amount specified in all the outputs 203 of a given transaction 152 is greater than the total amount pointed to by all its inputs 202, this is another basis for invalidity in most transaction models. Therefore such transactions will not be propagated nor included in a block 151.

Note that in UTXO-based transaction models, a given UTXO needs to be spent as a whole. It cannot “leave behind” a fraction of the amount defined in the UTXO as spent while another fraction is spent. However the amount from the UTXO can be split between multiple outputs of the next transaction. E.g. the amount defined in UTXO₀ in Tx₀ can be split between multiple UTXOs in Tx₁. Hence if Alice does not want to give Bob all of the amount defined in UTXO₀, she can use the remainder to give herself change in a second output of Tx₁, or pay another party.

In practice Alice will also usually need to include a fee for the bitcoin node 104 that successfully includes her transaction 104 in a block 151. If Alice does not include such a fee, Tx₀ may be rejected by the blockchain nodes 104, and hence although technically valid, may not be propagated and included in the blockchain 150 (the node protocol does not force blockchain nodes 104 to accept transactions 152 if they don't want). In some protocols, the transaction fee does not require its own separate output 203 (i.e. does not need a separate UTXO). Instead any difference between the total amount pointed to by the input(s) 202 and the total amount of specified in the output(s) 203 of a given transaction 152 is automatically given to the blockchain node 104 publishing the transaction. E.g. say a pointer to UTXO₀ is the only input to Tx₁, and Tx₁ has only one output UTXO₁. If the amount of the digital asset specified in UTXO₀ is greater than the amount specified in UTXO₁, then the difference may be assigned by the node 104 that wins the proof-of-work race to create the block containing UTXO₁. Alternatively or additionally however, it is not necessarily excluded that a transaction fee could be specified explicitly in its own one of the UTXOs 203 of the transaction 152.

Alice and Bob's digital assets consist of the UTXOs locked to them in any transactions 152 anywhere in the blockchain 150. Hence typically, the assets of a given party 103 are scattered throughout the UTXOs of various transactions 152 throughout the blockchain 150. There is no one number stored anywhere in the blockchain 150 that defines the total balance of a given party 103. It is the role of the wallet function in the client application 105 to collate together the values of all the various UTXOs which are locked to the respective party and have not yet been spent in another onward transaction. It can do this by querying the copy of the blockchain 150 as stored at any of the bitcoin nodes 104.

Note that the script code is often represented schematically (i.e. not using the exact language). For example, one may use operation codes (opcodes) to represent a particular function. “OP_ . . . ” refers to a particular opcode of the Script language. As an example, OP_RETURN is an opcode of the Script language that when preceded by OP_FALSE at the beginning of a locking script creates an unspendable output of a transaction that can store data within the transaction, and thereby record the data immutably in the blockchain 150. E.g. the data could comprise a document which it is desired to store in the blockchain.

Typically an input of a transaction contains a digital signature corresponding to a public key P_{A}. In embodiments this is based on the ECDSA using the elliptic curve secp256k1. A digital signature signs a particular piece of data. In some embodiments, for a given transaction the signature will sign part of the transaction input, and some or all of the transaction outputs. The particular parts of the outputs it signs depends on the SIGHASH flag. The SIGHASH flag is usually a 4-byte code included at the end of a signature to select which outputs are signed (and thus fixed at the time of signing).

The locking script is sometimes called “scriptPubKey” referring to the fact that it typically comprises the public key of the party to whom the respective transaction is locked. The unlocking script is sometimes called “scriptSig” referring to the fact that it typically supplies the corresponding signature. However, more generally it is not essential in all applications of a blockchain 150 that the condition for a UTXO to be redeemed comprises authenticating a signature. More generally the scripting language could be used to define any one or more conditions. Hence the more general terms “locking script” and “unlocking script” may be preferred.

As shown in FIG. 1, the client application on each of Alice and Bob's computer equipment 102a, 120b, respectively, may comprise additional communication functionality. This additional functionality enables Alice 103a to establish a separate side channel 107 with Bob 103b (at the instigation of either party or a third party). The side channel 107 enables exchange of data separately from the blockchain network. Such communication is sometimes referred to as “off-chain” communication. For instance this may be used to exchange a transaction 152 between Alice and Bob without the transaction (yet) being registered onto the blockchain network 106 or making its way onto the chain 150, until one of the parties chooses to broadcast it to the network 106. Sharing a transaction in this way is sometimes referred to as sharing a “transaction template”. A transaction template may lack one or more inputs and/or outputs that are required in order to form a complete transaction. Alternatively or additionally, the side channel 107 may be used to exchange any other transaction related data, such as keys, negotiated amounts or terms, data content, etc.

The side channel 107 may be established via the same packet-switched network 101 as the blockchain network 106. Alternatively or additionally, the side channel 301 may be established via a different network such as a mobile cellular network, or a local area network such as a local wireless network, or even a direct wired or wireless link between Alice and Bob's devices 102a, 102b. Generally, the side channel 107 as referred to anywhere herein may comprise any one or more links via one or more networking technologies or communication media for exchanging data “off-chain”, i.e. separately from the blockchain network 106. Where more than one link is used, then the bundle or collection of off-chain links as a whole may be referred to as the side channel 107. Note therefore that if it is said that Alice and Bob exchange certain pieces of information or data, or such like, over the side channel 107, then this does not necessarily imply all these pieces of data have to be send over exactly the same link or even the same type of network.

### Client Software

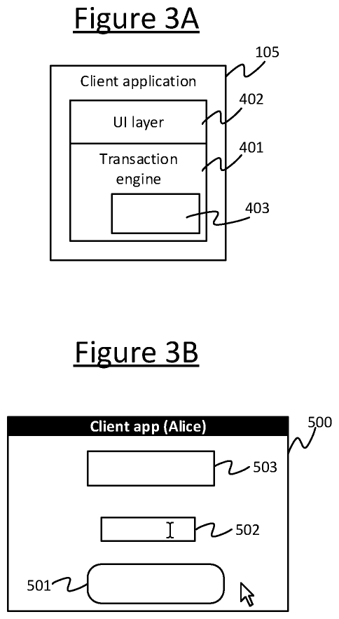

FIG. 3A illustrates an example implementation of the client application 105 for implementing embodiments of the presently disclosed scheme. The client application 105 comprises a transaction engine 401 and a user interface (UI) layer 402. The transaction engine 401 is configured to implement the underlying transaction-related functionality of the client 105, such as to formulate transactions 152, receive and/or send transactions and/or other data over the side channel 301, and/or send transactions to one or more nodes 104 to be propagated through the blockchain network 106, in accordance with the schemes discussed above and as discussed in further detail shortly. In accordance with embodiments disclosed herein, the transaction engine 401 of each client 105 comprises a function 403 for embedding data within the transaction, e.g. request data or reply data.

The UI layer 402 is configured to render a user interface via a user input/output (I/O) means of the respective user's computer equipment 102, including outputting information to the respective user 103 via a user output means of the equipment 102, and receiving inputs back from the respective user 103 via a user input means of the equipment 102. For example the user output means could comprise one or more display screens (touch or non-touch screen) for providing a visual output, one or more speakers for providing an audio output, and/or one or more haptic output devices for providing a tactile output, etc. The user input means could comprise for example the input array of one or more touch screens (the same or different as that/those used for the output means); one or more cursor-based devices such as mouse, trackpad or trackball; one or more microphones and speech or voice recognition algorithms for receiving a speech or vocal input; one or more gesture-based input devices for receiving the input in the form of manual or bodily gestures; or one or more mechanical buttons, switches or joysticks, etc.

Note: whilst the various functionality herein may be described as being integrated into the same client application 105, this is not necessarily limiting and instead they could be implemented in a suite of two or more distinct applications, e.g. one being a plug-in to the other or interfacing via an API (application programming interface). For instance, the functionality of the transaction engine 401 may be implemented in a separate application than the UI layer 402, or the functionality of a given module such as the transaction engine 401 could be split between more than one application. Nor is it excluded that some or all of the described functionality could be implemented at, say, the operating system layer. Where reference is made anywhere herein to a single or given application 105, or such like, it will be appreciated that this is just by way of example, and more generally the described functionality could be implemented in any form of software.

FIG. 3B gives a mock-up of an example of the user interface (UI) 500 which may be rendered by the UI layer 402 of the client application 105a on Alice's equipment 102a. It will be appreciated that a similar UI may be rendered by the client 105b on Bob's equipment 102b, or that of any other party.

By way of illustration FIG. 3B shows the UI 500 from Alice's perspective. The UI 500 may comprise one or more UI elements 501, 502, 502 rendered as distinct UI elements via the user output means.

For example, the UI elements may comprise one or more user-selectable elements 501 which may be, such as different on-screen buttons, or different options in a menu, or such like. The user input means is arranged to enable the user 103 (in this case Alice 103a) to select or otherwise operate one of the options, such as by clicking or touching the UI element on-screen, or speaking a name of the desired option (N.B. the term “manual” as used herein is meant only to contrast against automatic, and does not necessarily limit to the use of the hand or hands). The options enable the user (Alice) to embed data within a transaction.

Alternatively or additionally, the UI elements may comprise one or more data entry fields 502, through which the user can embed data within a transaction. These data entry fields are rendered via the user output means, e.g. on-screen, and the data can be entered into the fields through the user input means, e.g. a keyboard or touchscreen. Alternatively the data could be received orally for example based on speech recognition.

Alternatively or additionally, the UI elements may comprise one or more information elements 503 output to output information to the user. E.g. this/these could be rendered on screen or audibly.

It will be appreciated that the particular means of rendering the various UI elements, selecting the options and entering data is not material. The functionality of these UI elements will be discussed in more detail shortly. It will also be appreciated that the UI 500 shown in FIG. 3 is only a schematized mock-up and in practice it may comprise one or more further UI elements, which for conciseness are not illustrated.

### UTXO vs Account Based Models

A UTXO-based transaction model means that at any one time, a user's funds are a sum of their total unspent transaction outputs (UTXOs). The bitcoin blockchain is an example which makes use of a UTXO-based model. This type of model contrasts with account-based transactions such as those used in the Ethereum blockchain, in which a user's total incoming and outgoing expenses are combined into a current balance under one account.

The primary benefit of an account-based transaction model is the convenience of monitoring a single address compared to multiple transaction outputs. However, the convenience incurs a penalty to the user's privacy, since the account balance and transaction history are visible to everyone on the public ledger.

Take bitcoin as an example of a UTXO-based model and Ethereum as an example of an account-based model. Both bitcoin and Ethereum use the same secp256k1 elliptic curve and Elliptic Curve Digital Signature Algorithm (ECDSA) to sign transactions that are propagated around the respective public blockchain networks. ECDSA is currently considered secure. Yet if new hardware or cryptographic vulnerabilities in the algorithm are discovered in the future, it may eventually become possible to reverse engineer a private key from a signature. Another example of a security risk is a bad source of randomness for the ephemeral key used in digital signatures. The security of a user's funds is therefore potentially compromised from the reuse of a private key or a weak ephemeral key.

The nature of the UTXO model means that once a transaction output is spent, there is no benefit of trying to break a signature to gain the user's private key. When used as designed, each bitcoin address is only used once, and the balance is sent to brand new addresses.

In Ethereum, a single 20-byte address is used to identify an account. The account address is derived from the user's private key S as the right most 160-bits of the 256-bit Keccak hash of the corresponding ECDSA public key PK:

Address=R160[H_{KEC}(PK)]=R160[H_{KEC}(S·G)]

where R160[Data] is the last 20 bytes of the Data, H_{KEC}(▪) is the Keccak 256-bit hash function and G is the elliptic curve generator point.

Ethereum account addresses are used multiple times and it is standard practice to leave a balance in a user account. This means that once a malicious actor in the network possesses a signature for an account, they have both the time and incentive to attempt to crack it. The risk of theft is therefore much higher in the account model.

To address this security issue, an additional source of entropy in the form of a nonce—a counter used to make sure each transaction can only be processed once—is included in Ethereum accounts. However, this creates a bottleneck in the number of transactions that can be processed from a user account at any one time due to the sequential nature by which the nonce is updated. As a result, there are inherent scaling issues when adopting account-based transaction models.

### Alert Account

In general, embodiments of the present invention relate to an alert entity (e.g. a service provider) sending alert transactions to a user's alert account (i.e. a dedicated alert address) to notify the user about on-chain events. The alert transaction contains transaction identifiers (TxIDs) which the user can then use to look up the associated on-chain event.

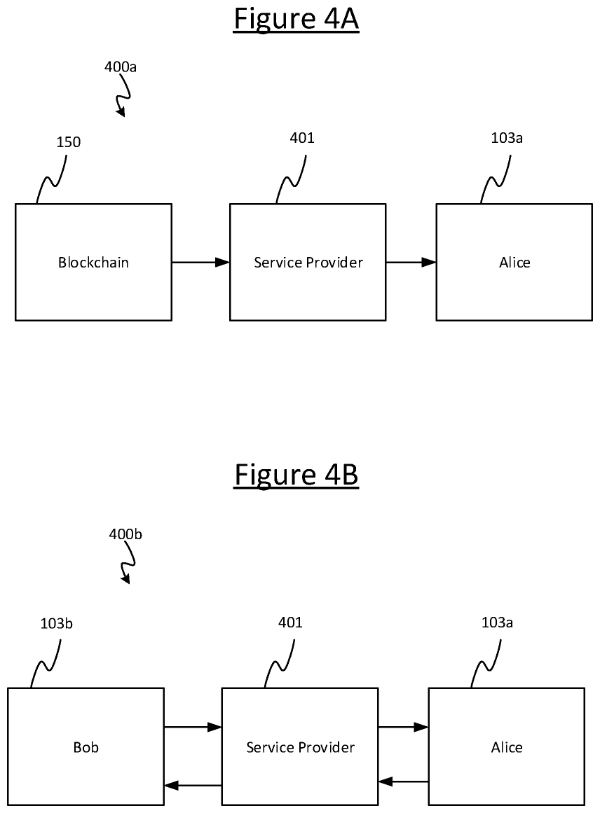

FIG. 4A schematically illustrates an example system 400a for implementing some embodiments. The system 400a comprises an alert entity (labelled “service provider”) 401 and a primary user (labelled “Alice”) 103a. These labels will be used throughout. Also shown is the blockchain 150. It will be appreciated that in practice the blockchain is maintained by blockchain nodes 104, and the system may comprise one or more blockchain nodes 104.

Whilst the primary user is referred to as Alice 103a, it should be noted that the primary user does not need to be able to perform each and every one of the functions attributed to Alice 103a above, whilst that is also not excluded. Rather, Alice 103a need only be able to perform the functions required to implement embodiments of the present invention. Furthermore, it will be appreciated that some or all of the functions described below as being performed by Alice 103a may in fact be performed by computer equipment 102a operated by Alice 103a. E.g. Alice 103a may use a wallet application 105a as described above.

In general the service provider 401 may take any form, e.g. a single user, a collection of users, an organisation, company, charity, etc. The service provider 401 operates respective computing equipment (not shown). The computer equipment of the service provider 401 comprises respective processing apparatus comprising one or more processors, e.g. one or more CPUs, GPUs, other accelerator processors, application specific processors, and/or FPGAs. The computer equipment the service provider 401 further comprises memory, i.e. computer-readable storage in the form of a non-transitory computer-readable medium or media. This memory may comprise one or more memory units employing one or more memory media, e.g. a magnetic medium such as hard disk; an electronic medium such as an SSD, flash memory or EEPROM; and/or an optical medium such as an optical disc drive. The memory on the computer equipment of the service provider 401 may store software comprising a respective instance of at least one client application (which may or may not differ from that of Alice's) arranged to run on the processing apparatus. It will be understood that any action attributed herein to the service provider 401 may be performed using the software run on the processing apparatus of the respective computer equipment. The computer equipment of the service provider 401 may comprise at least one user terminal, e.g. a desktop or laptop computer, a tablet, a smartphone, or a wearable device such as a smartwatch. The computer equipment of the service provider 401 may also comprise one or more other networked resources, such as cloud computing resources accessed via the user terminal.

FIG. 4B schematically illustrates another example system 400b embodiment of the present invention. This system 400b is similar to the system 400a of FIG. 4A, and additionally includes a secondary user Bob 103b. Bob 103b may perform some or all of the actions attributed to Bob 103b above with reference to FIGS. 1 to 3. This example system 400b also comprises one or more blockchain nodes 104 (not shown).

Returning now to FIG. 4A, the service provider 401 is configured to detect one or more on-chain events, and send an alert transaction to Alice 103a. An on-chain event is a transaction (referred to below as an “event transaction”) that relates to an event. For instance, an event transaction may include event data, e.g. data relating to an event. The term “on-chain” is therefore used to refer to something being recorded on the blockchain.

Each transaction recorded on the blockchain has a unique transaction identifier. The service provider 401 gathers one or more transaction identifiers, each identifying a respective event transaction, and includes them in an alert transaction which is sent to Alice 103a.

In some examples, the service provider 401 detects the on-chain events by monitoring the blockchain 150 for particular event transactions, e.g. those having an output locked to particular addresses, and/or including specific data. For instance, the service provider may obtain one, some or all of the transactions that are directed to one of Alice's (different) public keys, e.g. payment public keys, which could be derived deterministically from Alice's primary public key. E.g. Alice may wish to create a link between the primary public key and the payment public keys. The service provider may obtain one, some or all of the transactions containing a particular flag, e.g. a protocol flag, or a particular string, e.g. the word “Alice”, “weather”, “London”, etc. In some examples, the event transactions are sent directly to the service provider 401, and the service provider 401 consolidates the corresponding transaction identifiers into an alert transaction.

The alert transaction includes at least two transaction outputs. A first output is used to send the alert transaction to Alice's main public key. Alice's main public key is used as her alert account, i.e. all alert transactions are sent to the same main public key and thus recorded under her account. Preferably the main public key is not used for any other reason. A second output includes alert data (or an “alert payload”). The alert data contains the event transaction identifier(s). Other information which may be included in the alert data is discussed below. The second output may be an unspendable output, e.g. an output that cannot be unlocked and assigned to another public key. An output may be made unspendable by using specific opcodes, e.g. OP_FALSE OP_RETURN. It will be appreciated that whilst these particular opcodes are specific to the bitcoin blockchain, embodiments of the present invention may be implemented on other output-based blockchains. The skilled person will be familiar with how to render an output unspendable on those other blockchains. It is also not excluded that the alert data may be included in a spendable output. Again, the skilled person is familiar with how to include data in a spendable output, e.g. OP_PUSH and OP_DROP opcodes in the context of bitcoin.

Note that the alert transaction is only sent to Alice 103a in the sense that the first output of the alert transaction is locked to Alice's main public key. The alert transaction is not actually sent directly to Alice 103a, i.e. using a communication channel between Alice 103a and the service provider 401. Rather, the alert transaction is submitted to the blockchain network 106. Alice's client application 105 is then notified of the alert transaction. However, there is nothing preventing the service provider 401 sending the alert transaction to Alice 103a directly, and in some examples the service provider 401 may do this.

Having obtained the alert transaction, Alice 103a uses the event transaction identifier(s) to obtain the corresponding event transaction(s), and thus obtain the corresponding event data. For instance, Alice 103a may extract event data stored in an output of an event transaction. In some examples, the event data may be payment information, e.g. an amount of bitcoin (or more generally, digital assets of the blockchain) sent to one of Alice's public keys.

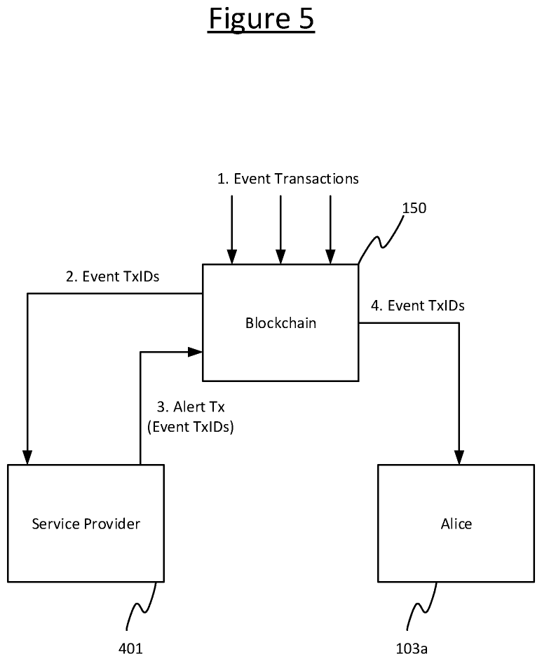

FIG. 5 illustrates this process in more detail. It will be appreciated that this is just one example implementation, and other implementations may use additional or alternative steps, or at least perform some steps in a different order. At step 1, one or more event transactions are submitted to and recorded on the blockchain 150. Each event transaction relates to a corresponding event, e.g. an activity. Note that an event may merely mean that information is stored in a transaction. That is the mere act of storing information relating to a particular topic may be classed as an event. At step 2, the service provider 401 obtains the transaction identifiers, one for each event transaction. At step 3, the service provider 401 sends an alert transaction to the blockchain 150. The alert transaction includes, amongst other things, an output comprising the event transaction identifiers. At step 4, Alice 103a obtains the alert transaction, from which she obtains the even transaction identifiers.

The alert transaction will now be described in more detail.

As discussed above, the alert transaction comprises an output locked to Alice's main public key. Alice's main public key may be a certified public key. In this context, a certified public key is a public key which a certificate authority has issued a certificate for, wherein the certificate attests to Alice's ownership of the public key. The certificate may be stored on the blockchain 150, and Alice 103a may provide a third party (e.g. the service provider 401) with a link (e.g. a transaction identifier) to the certificate-containing transaction.

The alert transaction comprises one or more inputs. One of the inputs may include a public key associated with the service provider 401, e.g. a certified public key. The service provider's public key is referred to below as an “alert public key”. The service provider 401 may have multiple alert public keys, e.g. to prevent having to re-use the same key when sending other instances of the alert transaction. The input of the alert transaction may also include a signature generated using a private key corresponding to the alert public key.

The alert transaction includes an output containing the alert data. Some or all of the alert data may be encrypted for privacy reasons. The encryption key used to encrypt the alert data may be generated based on, i.e. a function of, Alice's main public key. In some examples, the encryption key may also be generated based on the service provider's alert public key. For instance, Alice 103a and the service provider 401 may derive a common secret (sometimes called a shared secret) based on their own private key and the other's public key (e.g. Alice 103a uses her private key and the service provider's public key), and use the common secret as the encryption key. Or, a key derived from the common secret may be used as the common secret. That is, the common secret may be converted into the encryption key.

In some examples, as well as containing a transaction identifier of an event transaction, the alert data may also comprise an index (often called an outpoint) of a particular output of the event transaction. For instance, if the even data is stored in a second output of the event transaction, the alert data may include the transaction identifier and an index representing the second output of the event transaction, e.g. TxID∥index. This allows Alice 103a to identity the particular output of the event transaction that contains the event data relevant to her.

Along with the transaction identifiers, the alert data may also comprise an identifier of the service provider, e.g. to enable Alice 103a to identify the particular service provider 401 that has generated the alert. Additionally or alternatively, the alert data may comprise an event type, e.g. an indication of the type of event that that alert data relates to. Event types are discussed in more detail below. Also, the alert data may optionally include a summary of the event data contained in the corresponding event transactions.

FIG. 4B illustrates an example embodiment in which the service provider 401 acts as a kind of go-between, or middle-man, between Alice 103a and Bob 130b. Recall that Alice 103a is a primary user and Bob 103b is a secondary user. A primary user 103a is a user with an alert account (alert address), whereas a secondary user does not. In this embodiment, the service provider 401 is configured to notify Alice 103a of an “actionable event”. An actionable event is one which requires Alice 103a to take some form of action on-chain, i.e. using the blockchain.

In general, the service provider 401 detects a request transaction sent by Bob 103b (either to himself or to the service provider 401), and in response sends an alert transaction to Alice. This is similar to the embodiment of FIG. 4A, with the exception that Bob 103b is requesting a response from Alice 103a. For instance, Bob 103b may be requesting access to data owned by Alice 103a. Other forms of request are possible. The request transaction includes the request, e.g. in an unspendable output. In response to receiving the alert transaction, which includes a transaction identifier of the request transaction, Alice 103a generates a reply transaction (assuming that she accepts the request). Alice 103a sends the reply transaction to the service provider 401 and/or to Bob 103b. Again, this actually means that she submits the reply transaction to the blockchain network 106, and the reply transaction includes a respective output locked to the service provider 401 and/or a respective output locked to Bob 103b. The reply transaction includes reply data, and the reply data includes a reply to the request. In some examples, the reply data includes data that Bob 103b has requested. In other examples, the reply data includes a link to the requested data, e.g. a transaction identifier of an existing transaction on the blockchain 150 that includes the requested data. The reply data and/or the encrypted data may be encrypted. Alice 103a may include a decryption key for decrypting the requested data in the reply data, or she may otherwise provide Bob 103b with the decryption key. In some instances, the reply data (including the decryption key) is also encrypted, e.g. with a common secret known to Alice 103a and Bob 103b.

Depending on the use case, the service provider 401 may send a secondary alert transaction to Bob 103b. For instance, in response to detecting Bob's request transaction, the service provider 401 may send a secondary alert transaction to Bob 103b to notify Bob 103b that his request transaction has been detected. The secondary alert transaction may include (e.g. in an unspendable output) a payment public key associated with Alice 103a, so that Bob 103b can pay Alice 103a for the requested data. To do so, Bob 103b may generate a second request transaction, which includes an output locked to Alice's payment public key.

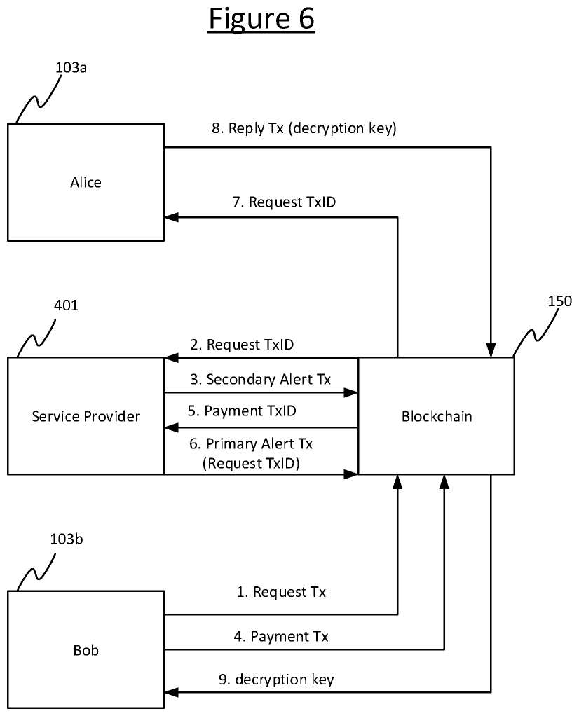

FIG. 6 illustrates this process in more detail. It will be appreciated that this is just one example implementation, and other implementations may use additional or alternative steps, or at least perform some steps in a different order. At step 1, Bob 103b sends a request transaction to the blockchain 150. The request transaction includes a data request and Bob's public key. At step 2, the service provider 401 detects the request transaction and obtains the request TxID. At step 3, the service provider 401 sends a secondary alert transaction to the blockchain 150, which is detected by Bob 103b. The secondary alert transaction contains Alice's payment public key and an output locked to Bob's public key. The secondary alert transaction also includes a TxID of a data transaction containing the requested data. At step 4, Bob 103s sends a payment transaction to Alice's payment public key. The service provider 401 monitors for payments sent to Alice's payment public key, or rather her payment address. This payment is detected at step 5, and at step 6 the service provider 401 sends a primary alert transaction to the blockchain 150. The primary alert transaction includes the request TxID and/or the payment TxID. Alice 103a obtains the request TxID and/or the payment TxID at step 7, and at step 8 she sends a reply transaction to the blockchain 150. The reply transaction includes reply data. The reply transaction includes a decryption key for decrypting the data in the data transaction. The reply transaction may also contain other data, e.g. a TxID of a data transaction. Bob 103b, at step 9, obtains the decryption key and uses it to obtain the data stored in data transaction.

In summary, there are three components of the alert account system—the user account, the alert transaction(s) and the event(s). Embodiments of these components will be now described in more detail.

### Main Roles

There are two main roles in the alert address system: the service provider (SP) 401 and the user 103a. The user 103a is a subscriber to the service. Two kinds of service are presented by the SP 401. The SP 401 offers the collection service of on-chain activities. The user 130a stipulates what kinds of on-chain events he or she wants to know. The SP will parse the blockchain 150, identify the events that match pre-specified criteria and communicate the applicable information to the user 103a. The SP 401 also mediates the communication between the user 103a and the creators 103b of the on-chain events. Some on-chain activities require the reception of responses from someone. The SP 401 will do the preliminary interactions with the event initiator 103b before prompting the user 103a to make sure that the user 103a can give the correct response. The motivation of the SP 401 is to conserve the users' considerable monitoring time and cut down peer-to-peer interaction time.

### User Account

The user account of the alert system preferably allocates a certified public key PK_{M} as their main account. This account is reserved solely to receive on-chain alert messages from the third-party service with which they register their certified public key. Note that the certified public key PK_{M} is not a key used by the user 103a for receiving or sending payments (excluding some minimal amount in the output of an alert transaction sent to the account that is nominal or close to zero in value). By restricting the movement of funds to this account, the user 103a is not vulnerable to theft from malicious actors.

All payment transactions should be directed to a different public key, which may be derived deterministically from the user's certified key should they wish to create a link between these keys for auditing purposes.

Should a user 103a wish to update their account to a new certified key, they can also make use of the deterministic key derivation methods. The designation of a certified key as a main account relative to a traditional account-based transaction model provides the following advantages:
Security—the user's private key is never reused in accordance with best practices for digital key management.
Privacy—the user 103a has full control on where their payments are stored as well as how they receive transactions containing data.
Flexibility—users 103a can use deterministic methods to link multiple purposed public keys (e.g. work-related, personal) under one account.
Scalability—multiple transactions can be processed simultaneously. The UTXO model does not depend on any accounts being updated or synchronised to accounts on the blockchain.
Regulatory compliance—the certified nature of the account ensures KYC/AML compliance and a method for privacy-conserving identity management.
Reduced cost—the user 103a is spared the expense of certifying multiple public keys by storing all their activity under one account.
Audit trail—the user 103a can spend UTXOs to a new certified public key and create an audit trail linking their previous account history to a new one.

### Alert Transaction

The user 103a stipulates the details of an on-chain event which triggers the alert address (AA) system to send an alert. The alert is delivered in the form of a blockchain transaction Tx_{AA:<Event>} from the SP 401 to the user's main account. The template of an alert transaction Tx_{AA:<Event>} is shown in in the table below, where:
PK_{SP} is the SP's public key—this key is denoted as PK_{SP} in the following transactions for simplicity in notation but can be updated regularly to observe best practices for digital key management.
PK_{M} is the certified public key of the user's main account; this key is not updated regularly.

TxID_{AA:<Event>}

| Inputs | | Outputs | |
|---|---|---|---|
| Value | Script | Value | Script |
| (x + y) | <SIG_{SP}><PK_{SP}> | x sats | OP_DUP OP_HASH160 < H₁₆₀(PK_{SP})> |
| sats | | | OP_EQUALVERIFY OP_CHECKSIG |
| | | y sats | OP_DUP OP_HASH160 < H₁₆₀(PK_{M})> |
| | | | OP_EQUALVERIFY OP_CHECKSIG |
| | | 0 sat | OP_FALSE OP_RETURN |
| | | | [Service provider identifier] |
| | | | [Event type] |
| | | | <Alert payload data> |

In this example the alert transaction Tx_{AA:<Event>} has three outputs as follows:
The first output (x sats) is a P2PKH used to specify a refund to the SP's public key PK_{SP}.
The second output (y sats) is a P2PKH used to specify an event should be sent to the user's main account PK_{M}.
The null data output is used to store arbitrary information related to the event.

### OP_RETURN Data

The OP_RETURN data is presented as the following fields:
Service provider identifier—indicates this alert transaction is sent by the SP 401 in the AA system.
Event type—indicates the event is nonactionable (01) or actionable (02).
Alert payload data—includes the event TxIDs and an alert summary. Note that if a field is not necessary for any alert summary, its bytes may be set to 0x00000000. In practice the alert payload data itself will be encrypted and only be accessed by the parties who hold the decryption keys. A shared secret may be generated using a secret value distribution method. The secret value may be converted into any standard key format such as AES 256 agreed in advance by the user 103a and the SP 401 to encrypt the alert payload data by the SP 401 and decrypt the data by the user 103a. The calculation of the shared secret requires the user 103a and the SP 401 to have exchanged public keys (separated from PK_{M} and PK_{SP}). The SP 401 wishes to send an encrypted alert payload data to the user 103a on-chain. The message signed by the SP 401 for generating the secret may be the hash of a subscription contract. The subscription contract is a digital file that the user 103a agrees the SP 401 to provide the alert service periodically. This secret is known only by the user 103a and the SP 401. The user 103a can present any relevant information with the decryption key to an auditor, such as the local tax authority.

The following table outlines the data structure of these fields.

| Field Entry | Size | Data Type | Description |
|---|---|---|---|
| SP identifier | 4 bytes | uint32_t | 0×41415350 |
| Event type | 1 byte | uint16_t | Single-byte identifier indicating |
| | | | whether the event is nonactionable |
| | | | (01) or actionable (02). |
| Location data | 32 bytes | char[32] | TxID of the on-chain event(s). |
| of on-chain | | | Note that there may be multiple |
| event(s) | | | events related TxIDs in some |
| | | | instances. |
| | 4 bytes | uint16_t | (Optional) vout: Output number |
| | | | of the event TxID. |
| Alert summary | 4 bytes | uint32_t | String encoding the alert to the user. |

The following is an example of the null data output in the alert transaction:

OP_FALSE OP_RETURN
0x41415350 - Service provider identifier (4 bytes)
0x01 - Event type (1 byte)
OP_PUSHDATA1 <payload length>
<
0x4d348912...87 - Event location data (32 bytes)
0x3ad21fac - Alert summary (4 bytes)
>

### Events

The alert address system encompasses two types of on-chain events:
Nonactionable Events (NE)—an event that does not require the user 103a to take on-chain actions to the alert TX_{AA:NE}.
Actionable Events (AE)—an event that requires the user 103a to take on-chain actions to the alert Tx_{AA:AE}.

### Nonactionable Events

Nonactionable events indicate that the communication between the user 103a and the SP 401 is unidirectional. The SP 401 is a data consolidator who consolidates the nonactionable events into an alert. The user 103a is the recipient of the alert. After being alerted, the user 103a reviews the alert payload data. The steps of the communication are presented as follows:
1) Blockchain→SP: the nonactionable events are detected by the SP 401.
2) SP÷User: the SP 401 delivers an alert Tx_{AA:NE} to the user 103ato inform the nonactionable events. The TxIDs of the nonactionable events are displayed in the OP_RETURN data.

The nonactionable alert Tx_{AA:NE} is similar to the schematic of an alert transaction (see above). The part changed is the OP_RETURN payload which stores the SP identifier, the event type, the TxID of the nonactionable event(s) and an alert summary if it is necessary.

### Actionable Events

The alert process of actionable events is more involved given that the user 103a needs to respond (on chain) to the alert. In the case of actionable events, the alert address system is a symmetric structure centred around the SP 401 and both sides of the SP are a respective user. Here, the system comprises two users, an ephemeral (secondary) user 103b and the primary user 103b.

The ephemeral user 103b is the event initiator (EI) who broadcasts the actionable events to the blockchain 150. There are two reasons of using the term ‘ephemeral’. First, it specifies that the EI is not the subscriber of the alert address system. Although the EI 103b will receive an ephemeral alert from the SP 401, the SP 401 will not send the continuous alert to the EI 103b. The object of the ephemeral alert will change as the actionable events change. Secondly, the ephemeral alert is used to distinguish the alert sent from the SP 401 to the subscriber 103a.

The primary user 103a is the subscriber of the alert address system. That means, the SP 401 provides the regular alert service to the primary user 130a. The SP 401 will monitor the blockchain 150 on behalf of the primary user 103a, and deliver the alert continuously regarding the detail of the events to the user's main account in the subscribe period. In what follows, Alice is the primary user 103a and Bob is the event initiator 103b.

The communications between Bob 103b and the SP 401 are below:
1) SP→Bob: the SP 401 sends an ephemeral alert TxID_{eA:AE} (see table below) to Bob 103b. The transactions of the on-chain actionable events are submitted by Bob 103b. The SP 401 monitors the blockchain 150 and captures the related events' TxIDs and Bob's public key PK_{B} from these transactions. After that, the SP 401 sends the ephemeral alert to Bob 103b to indicate that the actionable events are detected.

The ephemeral alert TxID_{eA:AE} has three outputs:
The first output (x sats) is a P2PKH used to specify a refund should be sent to the SP's public key PK_{SP}.
The second output (y sats) sent to Bob's public key PK_{B} is used to inform Bob 103b that the actionable events are captured by the SP 401.
The null data output is used to store the alert payload data.

TxID_{eA:AE}

| Inputs | | Outputs | |
|---|---|---|---|
| Value | Script | Value | Script |
| (x + y) | <SIG_{SP}><PK_{SP}> | x sats | OP_DUP OP_HASH160 |
| sats | | | < H₁₆₀ (PK_{SP})> OP_EQUALVERIFY OP_CHECKSIG |
| | | y sats | OP_DUP OP_HASH160 |
| | | | < H₁₆₀(PK_{S})> OP_EQUALVERIFY OP_CHECKSIG |
| | | 0 sat | OP_FALSE OP_RETURN |
| | | | 0×41415350 |
| | | | 0×02 |
| | | | <Alert payload data> |

2) Bob→SP: Bob 103b sends an ephemeral reply (transaction TxID_{eR:AE} (see table below) to the SP 401 to respond to the ephemeral alert. The ephemeral reply transaction TxID_{eR:AE} will spend the second output of the ephemeral alert TxID eA:AE. The ephemeral reply transaction is also referred to above as the second request transaction.

The ephemeral reply transaction TxID_{eR:AE} has three outputs:
The first output (y sats) is a P2PKH used to specify a refund should be sent to Bob's public key PK_{B}.
The second output (x sats) is a P2PKH used to specify a response to the ephemeral alert should be sent to the SP's public key PK_{SP}.
The null data output is used to store the reply payload data including the ephemeral alert TxID_{eA:AE}.

TxID_{eR:AE}

| Inputs | | Outputs | |
|---|---|---|---|
| TxID\|\|value | Script | Value | Script |
| TxID_{eA:AE}\|\|y sats | <SIG_{B}><PK_{B}> | y sats | OP_DUP OP_HASH160 |
| | | | <H₁₆₀(PK_{B})> OP_EQUALVERIFY OP_CHECKSIG |
| x sats | | x sats | OP_DUP OP_HASH160 |
| | | | < H₁₆₀(PK_{SP})> OP_EQUALVERIFY OP_CHECKSIG |
| | | 0 sat | OP_FALSE OP_RETURN |
| | | | 0×41415350 |
| | | | <Reply payload data> |

The following steps describe the communication process between the SP 401 and Alice 103a.
3) SP→Alice: the SP 401 delivers all actionable events to Alice 103a in the form of an alert TxID_{AA:AE}. The TxID_{AA:AE} is similar to the alert transaction template. The difference is to specify the SP identifier (0x41415350) and the event type (02) in the null data output of the TxID_{AA:AE}.
4) Alice→SP: Alice 103a sends a reply transaction TxID_{AA:R} (see table below [symbol] ) to the SP 401 to respond to the alert. The reply transaction TxID_{AA:R} will spend the second output of the alert TxID_{AA:AE}.

The reply transaction TxID_{AA:R} has three outputs:
The first output (y sats) is a P2PKH used to specify a refund should be sent to the Alice's main account PK_{M}.
The second output (x sats) is a P2PKH used to specify a response to the alert TxID_{AA:AE} should be sent to the SP's public key PK_{SP}.
The null data output is used to store the reply payload data including the alert TxID_{AA:AE}, the event TxIDs and a reply summary if necessary.

TxID_{AA:R}

| Inputs | | Outputs | |
|---|---|---|---|
| TxID\|\|vout | Script | Value | Script |
| TxID_{AA:AE}\|\|y sats | <SIG_{M}><PK_{M}> | y sats | OP_DUP OP_HASH160 |
| | | | < H₁₆₀(PK_{M})> OP_EQUALVERIFY OP_CHECKSIG |
| x sats | | x sats | OP_DUP OP_HASH160 |
| | | | < H₁₆₀(PK_{SP})> OP EQUALVERIFY OP_CHECKSIG |
| | | 0 sat | OP_FALSE OP_RETURN |
| | | | 0×41415350 |
| | | | 0×02 |
| | | | <Reply payload data> |

### EXAMPLE USE CASES

### Case One: Weather Temperature+Flight Cancellation (Nonactionable Events)

Case one assumes that nonactionable events are recorded in the blockchain 150 in the form of transactions by the related third parties.

Alice 103a would like to be alerted monthly with two kinds of things which will occur between 1 May and 30 Aug. 2020:
How many days will the weather temperature be 27° C. in the UK?
what flights from UK to China will be cancelled?

Alice 103a sends a request to the SP 401 to request that transactions relating to these events be sent to her user account. The SP 401 monitors the related transactions which record the weather temperature 27° C. and the cancelled flights during that period time, summarizes all relevant TxIDs (TxID _{WT:27},TxID_{FC:1},TxID_{FC:2}) and delivers an alert TxID_{AA:case one} (see table below) to Alice's main account PK_{M}.

TxID_{AA:caseone}

| Inputs | | Outputs | |
|---|---|---|---|
| Value | Script | Value | Script |
| (x + y) sats | <SIG_{SP}><PK_{SP}> | x sats | OP_DUP OP_HASH160 |
| | | | < H₁₆₀(PK_{SP})> OP_EQUALVERIFY OP_CHECKSIG |
| | | y sats | OP_DUP OP_HASH160 |
| | | | < H₁₆₀(PK_{M})> OP_EQUALVERIFY OP_CHECKSIG |
| | | 0 sat | OP_FALSE OP_RETURN 0×41415350 0×01 |
| | | | OP_PUSHDATA1 |
| | | | < TxID_{WT:27} TxID_{FC:1} TxID_{FC:2} ″1 day over |
| | | | 27° C. and 2 cancelled flights in May″> |

### Case Two: a List of Transactions Sent to Alice (Nonactionable Events)

Case two considers a list of transactions Carl has sent to Alice 103a (e.g. payment transactions sent to Alice 103a from Carl and/or the other people in one month) as nonactionable events. Alice 103a would like to review the list of transactions in her main account for some purposes such as auditing. The SP 401 consolidates them into Alice's main account PK_{M} in the form of an alert transaction. The difference compared with TxID_{AA:case one} is the encrypted alert payload data that stores the list of TxIDs of Alice's received payment transactions and an alert summary indicating the number of detected transactions.

Case two means the user (Alice) of the alert address system can simulate the benefits of an account-based system (one fixed address) on a UTXO based system (one address per transaction). If the private key of Alice's main account is hacked, the worst thing that happens is Alice loses some privacy, but she will not use any funds.

### Case Three: Data Access (Actionable Events)

For the actionable events, Alice 103a not only reviews the alert payload data, but also needs to take some on-chain actions to the alert. Case three states data access as an actionable event and has the following assumptions:
There are three entities: Alice (User) 103a, the SP 401 and Bob (EI) 103b.
Alice 103a stores her healthcare data in the form of a blockchain transaction TxID_{data} in the blockchain 150. The data is encrypted and only can be accessed with a decryption key. A new decryption key must be generated each time after the data has been accessed.
Alice 103a would like to sell her data and authorizes the SP 401 to alert her for any deal.
The SP 401 monitors the blockchain on behalf of Alice 103a. The SP 401 has the information of TxID_{data}, Alice's main account PK_{M} and the payment public key PK_{A}.
Bob 103b broadcasts a request transaction TxID_{request} (see table below) to the blockchain network 106 to state that he would like to access some healthcare data for his research project. Bob 103b cannot access the gathered data without the owner's permission.

TxID_{request}

| Inputs | | Outputs | |
|---|---|---|---|
| Value | Script | Value | Script |
| x sats | <SIG_{B}><PK_{B}> | x sats | OP_DUP OP_HASH160 < H₁₆₀(PK_{B})> |
| | | | OP_EQUALVERIFY OP_CHECKSIG |
| | | 0 sat | OP_FALSE OP_RETURN |
| | | | <Healthcare data access> |

This use case is implemented as follows:
1. The SP 401 detects the request transaction TxIDrequest and captures Bob's public key PK_{B}. By reviewing the request, the SP 401 knows that Alice 103a has the matched healthcare data.
2. The SP 401 sends an ephemeral alert TxIDeA:case three (see table below) to Bob 103b that the SP 401 has reviewed his request and Alice 103a has the matched data. The ephemeral alert payload data contains Alice's payment public key PK_{A} and Alice's data TxID_{data}.

TxID_{eA:case three}

| Inputs | | Outputs | |
|---|---|---|---|
| Value | Script | Value | Script |
| (x + y) | <SIG_{SP}><PK_{SP}> | x sats | OP_DUP OP_HASH160 < H₁₆₀(PK_{SP}) > |
| sats | | | OP_EQUALVERIFY OP_CHECKSIG |
| | | y sats | OP_DUP OP_HASH160 < H₁₆₀(PK_{B}) > |
| | | | OP_EQUALVERIFY OP_CHECKSIG |
| | | 0 sat | OP_FALSE OP_RETURN |
| | | | 0×41415350 < TxID_{data}, PK_{A}) > |

3. After receiving the ephemeral alert, Bob 103b want to access Alice's data and sends an ephemeral reply TxID_{eR:case three} (see table below [symbol] ) to respond the ephemeral alert. The ephemeral reply transaction TxID_{eR:case three} will spend the second output of the ephemeral alert TxID_{eA:case three}.

The ephemeral reply has four outputs:
The first output (y sats) is a P2PKH used to specify a refund should be sent to the Bob's public key PK_{B}.
The second output (x sats) is a P2PKH used to specify a response to the ephemeral alert should be sent to the SP's public key PK_{SP}.
The third output (z sats) is a P2PKH used to pay to Alice's payment public key PK_{A} for data access.
The null data output is used to store the reply payload data including the ephemeral alert TxID_{eA:case three} and TxID_{data}.

TxID_{eR:case three}

| Inputs | | Outputs | |
|---|---|---|---|
| TxID\|\|value | Script | Value | Script |
| TxID_{eA:AE}\|\|y sats | <SIG_{B}><PK_{B}> | y sats | OP_DUP OP_HASH160 |
| | | | < H₁₆₀(PK_{B}) > OP_EQUALVERIFY OP_CHECKSIG |
| (x + z) sats | | x sats | OP_DUP OP_HASH160 |
| | | | < H₁₆₀(PK_{SP})> OP_EQUALVERIFY OP_CHECKSIG |
| | | z sats | OP_DUP OP_HASH160 |
| | | | < H₁₆₀(PK_{A}) > OP_EQUALVERIFY OP_CHECKSIG |
| | | 0 sat | OP_FALSE OP_RETURN |
| | | | 0×41415350 |
| | | | < TxID_{eA:case three}, TxID_{data} > |

4. The SP 401 sends an alert TxID_{AA:case three} (see table below) to Alice's main account PK_{M}:
The first output (x sats) is a P2PKH used to specify a refund should be sent to the SP's public key PK_{SP}.
The second output (y sats) is used to specify all relevant actionable events should be sent to Alice's main account PK_{M}.
The null data output is used to store the alert payload data including the SP identifier, the event type (02), TxID_{request}, TxID_{eR:case three} and Bob's public key PK_{B}.

TxID_{AA:case three}

| Inputs | | Outputs | |
|---|---|---|---|
| Value | Script | Value | Script |
| (x + y) | <SIG_{SP}><PK_{SP}> | x sats | OP_DUP OP_HASH160 |
| sats | | | <H₁₆₀(PK_{SP})> OP_EQUALVERIFY |
| | | | OP_CHECKSIG |
| | | y sats | OP_DUP OP_HASH160 |
| | | | < H₁₆₀(PK_{M})> OP_EQUALVERIFY |
| | | | OP_CHECKSIG |
| | | 0 sat | OP_FALSE OP_RETURN |
| | | | 0×41415350 |
| | | | 0×02 |
| | | | < TxID_{request}, TxID_{eR:case three}, PK_{B} > |

5. Alice 103a receives the alert from the SP 401 that Bob 103b would like to access her healthcare data. Alice 103a responds to the alert in the form of a reply TxID_{AA:R} (see table below [symbol] ). The reply payload data includes TxID_{data}, the decryption key and a reply summary. The first input of the reply TxID_{AA:R} spends the second output of the alert TxID_{AA:case three}.

TxID_{AA:R}

| Inputs | | Outputs | |
|---|---|---|---|
| TxID\|\|value | Script | Value | Script |
| TxID_{AA:AE}\|\|y sats | <SIG_{M}><PK_{M}> | y sats | OP_DUP OP_HASH160 |
| | | | < H₁₆₀(PK_{M})> OP_EQUALVERIFY OP_CHECKSIG |
| x sats | | x sats | OP_DUP OP_HASH160 |
| | | | < H₁₆₀(PK_{B})> OP_EQUALVERIFY OP_CHECKSIG |
| | | 0 sat | OP_FALSE OP_RETURN |
| | | | 0×41415350 |
| | | | 0×02 |
| | | | <TxID_{request}, TxID_{data}, |
| | | | decryption key (data) > |

This process can be summarised as follows:
1) Bob 103b broadcasts a request Tx to the blockchain network 106 to advertise his demand.
2) The SP 401 monitors the blockchain network 106 and detects Bob's request. The SP 401 creates an ephemeral alert Tx to the blockchain network 106 to inform Bob 103b that his request has been reviewed and Alice 103a has the fitted data to his demand.
3) Bob 103b receives the ephemeral alert Tx and agrees to access Alice's data. Bob 103b sends the ephemeral reply Tx to the SP 401 and Alice 103a.
4) The SP 401 broadcasts an alert Tx to the blockchain network to inform Alice 103a that Bob 103b would like to access her data.
5) Alice 103a creates a reply Tx to permit Bob 103b to access her data.

### CONCLUSION

Other variants or use cases of the disclosed techniques may become apparent to the person skilled in the art once given the disclosure herein. The scope of the disclosure is not limited by the described embodiments but only by the accompanying claims.

For instance, some embodiments above have been described in terms of a bitcoin network 106, bitcoin blockchain 150 and bitcoin nodes 104. However it will be appreciated that the bitcoin blockchain is one particular example of a blockchain 150 and the above description may apply generally to any blockchain. That is, the present invention is in by no way limited to the bitcoin blockchain. More generally, any reference above to bitcoin network 106, bitcoin blockchain 150 and bitcoin nodes 104 may be replaced with reference to a blockchain network 106, blockchain 150 and blockchain node 104 respectively. The blockchain, blockchain network and/or blockchain nodes may share some or all of the described properties of the bitcoin blockchain 150, bitcoin network 106 and bitcoin nodes 104 as described above.

In preferred embodiments of the invention, the blockchain network 106 is the bitcoin network and bitcoin nodes 104 perform at least all of the described functions of creating, publishing, propagating and storing blocks 151 of the blockchain 150. It is not excluded that there may be other network entities (or network elements) that only perform one or some but not all of these functions. That is, a network entity may perform the function of propagating and/or storing blocks without creating and publishing blocks (recall that these entities are not considered nodes of the preferred bitcoin network 106).

In non-preferred embodiments of the invention, the blockchain network 106 may not be the bitcoin network. In these embodiments, it is not excluded that a node may perform at least one or some but not all of the functions of creating, publishing, propagating and storing blocks 151 of the blockchain 150. For instance, on those other blockchain networks a “node” may be used to refer to a network entity that is configured to create and publish blocks 151 but not store and/or propagate those blocks 151 to other nodes.

Even more generally, any reference to the term “bitcoin node” 104 above may be replaced with the term “network entity” or “network element”, wherein such an entity/element is configured to perform some or all of the roles of creating, publishing, propagating and storing blocks. The functions of such a network entity/element may be implemented in hardware in the same way described above with reference to a blockchain node 104.

It will be appreciated that the above embodiments have been described by way of example only. More generally there may be provided a method, apparatus or program in accordance with any one or more of the following Statements.

Statement 1. A computer-implemented method of alerting users to on-chain events, wherein a primary user is associated with a primary user public key, and wherein the method is performed by an alerting entity and comprises: identifying one or more event transactions, wherein each event transaction comprises respective event data; generating a primary alert transaction, wherein the primary alert transaction comprises a first output locked to the primary user public key, and a second output comprising alert data, and wherein the alert data comprises a respective identifier of each identified event transaction; and transmitting the primary alert transaction to the blockchain network.

Each event transaction is a respective on-chain event, i.e. an event which has been recorded on the blockchain.

Transmitting the primary alert transaction to the blockchain network may comprise broadcasting the primary alert transaction to the blockchain network.

The identifier of event transaction may be a transaction identifier, i.e. a TxID.

Statement 2. The method of statement 1, wherein the primary user public key is a certified public key.

A certified public key is a public key which has been certified as belonging to a particular user. In other words, the primary user public key may be a public key certified as belonging to the primary user.

The certified public key may be used as a user account to securely consolidate all of the primary user's blockchain activity in one place.

Statement 3. The method of statement 1 or statement 2, wherein identifying at least one of the one or more event transactions comprises scanning the blockchain for event transactions comprising the respective event data.

The event data may be a payment to a public key associated with the primary user.

Statement 4. The method of any preceding statement, wherein the primary alert transaction comprises an input comprising a public key associated with the alerting entity.

In other words, the alerting entity (e.g. a service provider) signs the primary alert transaction.

Statement 5. The method of statement 4, wherein identifying at least one of the one or more event transactions comprises identifying an event transaction that comprises an output locked to the public key associated with the alerting entity and/or a public key associated with the primary user.

Statement 6. The method of any preceding statement, wherein the alert data is encrypted.

The alert data may be encrypted by the alerting entity.

Statement 7. The method of statement 6, wherein the alert data is encrypted with an encryption key generated at least in part based on a public key associated with the primary user.

E.g. the primary user public key.

Statement 8. The method of statement 7 when dependent on statement 4, wherein the encryption key is generated at least in part based on a private key corresponding to the public key associated with the alerting entity.

Statement 9. The method of any preceding statement, wherein the alert data comprises, for at least one of the respective identifiers of the respective event transactions, a corresponding output index of an output of the respective event transaction that comprises the event data.

E.g. a transaction identifier concatenated with an output index.

Statement 10. The method of any preceding statement, wherein identifying the one or more event transactions comprises identifying multiple event transactions.

Statement 11. The method of any preceding statement, wherein the alert data comprises an identifier of the alerting entity and/or an event type corresponding to the one or more event transactions.

Statement 12. The method of any preceding statement, wherein the second output is an unspendable output.

Statement 13. The method of any preceding statement, wherein at least one of the event transactions corresponds to an actionable event requiring the primary user to provide a secondary user with requested data, and wherein the alert data comprises a public key associated with the secondary user.

Statement 14. The method of statement 13, wherein the identifying of the at least one event transaction corresponding to an actionable event comprises identifying an event transaction comprising an output locked to, or signed by, the public key associated with the secondary user.

Statement 15. The method of statement 14, wherein the method comprises: generating a secondary alert transaction, wherein the secondary alert transaction comprises a first output locked to the public key associated with the secondary user, and a second output comprising a payment public key associated with the primary user; and transmitting the secondary alert transaction to the blockchain network.

The payment public key is distinct from the primary user public key. For instance, the payment public key may be derived from (i.e. linked to) the primary user public key. As a specific example, the payment public key may be derived from the primary user's certified public key.

The second output may be an unspendable output.

Statement 16. The method of statement 15, wherein the blockchain comprises a data transaction comprising the requested data, and wherein the second output of the secondary alert transaction comprises a respective identifier of the data transaction.

The identifier may be a transaction identifier, or the identifier may take other forms.

Statement 17. A computer-implemented method of obtaining on-chain events, wherein a blockchain comprises one or more event transactions, each event transaction comprising respective event data, wherein the method is performed by a user associated with a user public key, and wherein the method comprises: obtaining an alert transaction, wherein the alert transaction comprises a first output locked to the user public key, and a second output comprising alert data, and wherein the alert data comprises a respective identifier of one or more event transactions; and using at least one respective identifier of a respective event transaction to obtain the respective event data.

Statement 18. The method of statement 17, wherein the user public key is a certified public key.

The certified public key may act as a user account, with the alerting entity sending alert transactions to the user account. This consolidates the user's activity under one account.

Statement 19. The method of statement 17 or statement 18, wherein the alert transaction comprises an input comprising a public key associated with an alerting entity.

Statement 20. The method of any of statement 17 to 19, wherein the alert data is encrypted.

Statement 21. The method of statement 20, wherein the alert data is encrypted with an encryption key generated at least in part based on a private key associated with the user, and/or the public key associated with the alerting entity.

Statement 22. The method of any of statements 17 to 21, wherein the method is performed by a primary user, and wherein the alert transaction is a primary alert transaction.

Statement 23. The method of statement 22, wherein the method comprises sending a request to the alerting entity to be alerted of one or more types of on-chain events.

The request may be sent using a transaction or an off-chain message.

Statement 24. The method of statement 22 or statement 23, wherein at least one of the on-chain events is an actionable event requiring the primary user to provide a secondary user with requested data.

Statement 25. The method of statement 24, wherein the alert data comprises a public key associated with the secondary user, and wherein the method comprises: generating a reply transaction, wherein the reply transaction comprises a first output locked to the public key associated with the secondary user, and a second output comprising reply data, wherein the reply data relates to the requested data; and transmitting the reply transaction to the blockchain network.

The reply transaction may comprise an input configured to unlock the first output of the primary alert transaction.

The reply data may be encrypted, e.g. with a public key associated with the secondary user. Or, the encryption key may be generated based on the secondary user's public key and/or the primary user's private key.

Statement 26. The method of statement 25, wherein the blockchain comprises a data transaction comprising the requested data.

Optionally, the second output of the reply transaction may comprise a respective identifier of the data transaction.

Statement 27. The method of statement 25 or statement 26, wherein the requested data is encrypted, and wherein the second output of the reply transaction comprises a decryption key for decrypting the requested data.

Statement 28. The method of any of statements 17 to 19, wherein the method is performed by a secondary user, and wherein the alert transaction is a secondary alert transaction.

In some examples, the alert data may be partially encrypted, i.e. some of the alert data may be encrypted. For instance, the alert data may contain a request for access to healthcare data in plaintext, whilst the details of the type of healthcare data that is being requested is encrypted.

Statement 29. The method of statement 28, wherein the method comprises: generating a first request transaction, wherein the first request transaction comprises a first output locked to the user public key associated with the secondary user, and a second output comprising a request for data; and transmitting the first request transaction to the blockchain network.

Statement 30. The method of statement 29, wherein the alert data comprises a payment public key associated with the primary user, and wherein the method comprises: generating a second request transaction, wherein the second request transaction comprises a first output locked to the payment public key associated with the primary user, and a second output locked to the main alert public key, and a third output comprising an identifier of the requested data; and transmitting the second request transaction to the blockchain network.

The second request transaction may comprise an input configured to unlock the first output of the secondary alert transaction.

Statement 31. The method of statement 30, wherein the blockchain comprises a data transaction comprising the requested data, and wherein the identifier of the requested data comprises a respective identifier of the data transaction.

Statement 32. The method of statement 30 or statement 31, wherein the requested data is encrypted, and wherein the method comprises receiving a decryption key from the primary user for decrypting the requested data.

Statement 33. The method of statement 32, wherein the receiving of the decryption key comprises obtaining the decryption key from a transaction sent to the blockchain network by the primary user.

Statement 34. Computer equipment comprising: memory comprising one or more memory units; and processing apparatus comprising one or more processing units, wherein the memory stores code arranged to run on the processing apparatus, the code being configured so as when on the processing apparatus to perform the method of any of statements 1 to 33.

Statement 35. A computer program embodied on computer-readable storage and configured so as, when run on one or more processors, to perform the method of any of statements 1 to 33.

According to another aspect disclosed herein, there may be provided a method comprising the actions of the alerting entity and the primary user. There may also be provided a method comprising the actions of the alerting entity, the primary user and the secondary user.

According to another aspect disclosed herein, there may be provided a system comprising the computer equipment of the alerting entity and the primary user. There may also be provided a system comprising the computer equipment of the alerting entity, the primary user and the secondary user.

1. A computer-implemented method of alerting users to on-chain events, wherein a primary user is associated with a primary user public key, and wherein the method is performed by an alerting entity and comprises:
identifying one or more event transactions, wherein each event transaction comprises respective event data;
generating a primary alert transaction, wherein the primary alert transaction comprises a first output locked to the primary user public key, and a second output comprising alert data, and wherein the alert data comprises a respective identifier of each identified event transaction; and
transmitting the primary alert transaction to a blockchain network.

2. The method of claim 1, wherein the primary user public key is a certified public key.

3. The method of claim 1, wherein identifying at least one of the one or more event transactions comprises scanning the blockchain for event transactions comprising the respective event data.

4. The method of claim 1, wherein the primary alert transaction comprises an input comprising a public key associated with the alerting entity.

5. The method of claim 4, wherein identifying at least one of the one or more event transactions comprises identifying an event transaction that comprises an output locked to the public key associated with the alerting entity and/or a public key associated with the primary user.

6. The method of claim 1, wherein the alert data is encrypted.

7. The method of claim 6, wherein the alert data is encrypted with an encryption key generated at least in part based on a public key associated with the primary user.

8. The method of claim 7, wherein the primary alert transaction comprises an input comprising a public key associated with the alerting entity and the encryption key is generated at least in part based on a private key corresponding to the public key associated with the alerting entity.

9. The method of claim 1, wherein the alert data comprises, for at least one of the respective identifiers of the respective event transactions, a corresponding output index of an output of the respective event transaction that comprises the event data.

10. The method of claim 1, wherein identifying the one or more event transactions comprises identifying multiple event transactions.

11. The method of claim 1, wherein the alert data comprises an identifier of the alerting entity and/or an event type corresponding to the one or more event transactions.

12. (canceled)

13. The method of claim 1, wherein at least one of the event transactions corresponds to an actionable event requiring the primary user to provide a secondary user with requested data, and wherein the alert data comprises a public key associated with the secondary user.

14. The method of claim 13, wherein the identifying of the at least one event transaction corresponding to an actionable event comprises identifying an event transaction comprising an output locked to, or signed by, the public key associated with the secondary user.

15. The method of claim 14, wherein the method comprises:
generating a secondary alert transaction, wherein the secondary alert transaction comprises a first output locked to the public key associated with the secondary user, and a second output comprising a payment public key associated with the primary user; and
transmitting the secondary alert transaction to the blockchain network.

16. The method of claim 15, wherein a blockchain comprises a data transaction comprising the requested data, and wherein the second output of the secondary alert transaction comprises a respective identifier of the data transaction.

17. A computer-implemented method of obtaining on-chain events, wherein a blockchain comprises one or more event transactions, each event transaction comprising respective event data, wherein the method is performed by a user associated with a user public key, and wherein the method comprises:
obtaining an alert transaction, wherein the alert transaction comprises a first output locked to the user public key, and a second output comprising alert data, and wherein the alert data comprises a respective identifier of one or more event transactions; and
using at least one respective identifier of a respective event transaction to obtain the respective event data.

18-23. (canceled)

24. The method of claim 17, wherein at least one of the on-chain events is an actionable event requiring the user to provide a secondary user with requested data.

25. The method of claim 24, wherein the alert data comprises a public key associated with the secondary user, and wherein the method comprises:
generating a reply transaction, wherein the reply transaction comprises a first output locked to the public key associated with the secondary user, and a second output comprising reply data, wherein the reply data relates to the requested data; and
transmitting the reply transaction to a blockchain network.

26-33. (canceled)

34. Computer equipment comprising:
memory comprising one or more memory units; and
processing apparatus comprising one or more processing units, wherein the memory stores code arranged to run on the processing apparatus, the code being configured so as when run on the processing apparatus, the processing apparatus performs a method of alerting users to on-chain events, wherein a primary user is associated with a primary user public key, and wherein the method is performed by an alerting entity and comprises:
identifying one or more event transactions, wherein each event transaction comprises respective event data;
generating a primary alert transaction, wherein the primary alert transaction comprises a first output locked to the primary user public key, and a second output comprising alert data, and wherein the alert data comprises a respective identifier of each identified event transaction; and
transmitting the primary alert transaction to a blockchain network.

35. A computer program embodied on a non-transitory computer-readable storage medium and configured so as, when run on one or more processors, the one or more processors perform a method of alerting users to on-chain events, wherein a primary user is associated with a primary user public key, and wherein the method is performed by an alerting entity and comprises:
identifying one or more event transactions, wherein each event transaction comprises respective event data;
generating a primary alert transaction, wherein the primary alert transaction comprises a first output locked to the primary user public key, and a second output comprising alert data, and wherein the alert data comprises a respective identifier of each identified event transaction; and
transmitting the primary alert transaction to a blockchain.
